(19) United States
(12) Patent Application Publication
(10) Pub. No.: US 2021/0376672 A1
(43) Pub. Date: Dec. 2, 2021

(54) MOTOR

(71) Applicant: MINEBEA MITSUMI Inc., Nagano (JP)

(72) Inventors: Minoru KURODA, Kitasaku-gun (JP); Hirofumi OHBA, Kitasaku-gun (JP)

(21) Appl. No.: 17/330,761

(22) Filed: May 26, 2021

(30) Foreign Application Priority Data
May 29, 2020 (JP) 2020-095085
Aug. 4, 2020 (JP) 2020-132133

(51) Int. Cl. H02K 1/26; H02K 3/18; H02K 23/40

(52) U.S. Cl. CPC H02K 1/26; H02K 23/40; H02K 3/18

(57) ABSTRACT

A motor includes: a magnet including a plurality of magnetic poles; a plurality of slots opposing the magnet; a coil wound around each of the plurality of slots; a commutator including a plurality of segments; and a plurality of brushes, each of the plurality of brushes including a contact portion contacting two adjacent segments among the plurality of segments, wherein both ends of the coil are connected to the two segments among the plurality of segments, and another segment is arranged between the two segments, one ends of two adjacent coils are connected to one segment of the two segments, and a segment connected to one ends of two adjacent coils and the another segment between two segments connected to either coil different from the two adjacent coils have the same potential.

### CROSS-REFERENCE TO RELATED APPLICATIONS

This application claims the benefit of Japanese Application Nos. JP2020-095085 filed on May 29, 2020, and JP2020-132133 filed on Aug. 4, 2020, the entire disclosures of which are hereby incorporated herein by reference.

### BACKGROUND OF THE INVENTION

### 1. Field of the Invention

The present invention relates to a motor.

### 2. Description of the Related Art

In a DC motor using a commutator and a brush, so-called concentrated winding in which an electric wiring is wound around each of a plurality of slots (magnetic pole portions) may be adopted for a purpose of size reduction and weight reduction. In a concentrated winding brush motor, generally, since a width of the brush is smaller than a width of segments of the commutator and cannot be made large, the brush tends to run wild when extending over a slit of the commutator (a gap between adjacent segments). Therefore, the concentrated winding brush motor is disadvantageous in noise reduction (JP-A-2008-278689).

### SUMMARY OF THE INVENTION

The invention has been made in view of the above background, and an object of the invention is to provide a concentrated winding brush motor with a reduced level of noise.

The above object is achieved by any one of the following five inventions of first to fifth inventions.

That is, as one aspect of a motor according to the first invention, the motor includes:

a magnet including a plurality of magnetic poles;

a plurality of slots opposing the magnet;

a coil wound around each of the plurality of slots;

a commutator including a plurality of segments; and

a plurality of brushes, each of the plurality of brushes including a contact portion contacting two adjacent segments among the plurality of segments, wherein

both ends of the coil are connected to the two segments among the plurality of segments, and another segment not connected to both ends of the coil is arranged between the two segments,

one ends of two adjacent coils are connected to one segment of the two segments, and

a segment connected to one ends of two adjacent coils and the another segment between two segments connected to either coil different from the two adjacent coils have the same potential.

In the first invention, in a circumferential direction of the commutator, a position of the segment connected to one ends of two adjacent coils and a position of the another segment having the same potential as potential of the segment are in a rotationally symmetrical positional relationship.

Meanwhile, as one aspect of a motor according to the second invention, the motor includes:

a magnet including a plurality of magnetic poles;

a plurality of slots opposing the magnet;

a coil wound around each of the plurality of slots;

a commutator including a plurality of segments; and

a plurality of brushes, each of the plurality of brushes including a contact portion contacting two adjacent segments among the plurality of segments, wherein

both ends of the coil are connected to two segments among the plurality of segments, and another two segments are arranged between the two segments, the another two segments not being connected to the both ends of the coil,

one ends of two coils adjacent to both sides of the coil are respectively connected to the another two segments, and

in a circumferential direction of the commutator, the segments in a rotationally symmetrical positional relationship have the same potential.

In the first or second invention, the magnet includes an even number of magnetic poles,

the number of the slots is m, m being an odd number, and

the brush contacts two or more of the segments.

In the first or second invention, a width of a contact portion of the brush with the commutator in the circumferential direction of the commutator is x,

a width of the segment in the circumferential direction of the commutator is y, and

when a gap between the two adjacent segments in the circumferential direction of the commutator is z, the following relational expression (1) is satisfied.

2y+z>x>y+2z relational expression (1)

In the first or second invention, a width of a contact portion of the brush contacting the commutator in the circumferential direction of the commutator is x,

a width of the segment in the circumferential direction of the commutator is y, and

when a gap between the two adjacent segments in the circumferential direction of the commutator is z, the following relational expression (2) is satisfied.

3y+2z>x>2y+3z relational expression (2)

As one aspect of a motor according to the third invention, the motor includes:

a magnet including a plurality of magnetic poles;

a plurality of slots opposing the magnet;

a coil wound around each of the plurality of slots;

a commutator including a plurality of segments; and

a plurality of brushes, each of the plurality of brushes including a contact portion contacting two adjacent segments among the plurality of segments, wherein

both ends of the coil are connected to two segments among the plurality of segments, and one or two or more other segments are arranged between the two segments,

one ends of two adjacent coils are connected to one segment of the two segments, and

in a circumferential direction of the commutator, the segments in a rotationally symmetrical positional relationship have the same potential.

As one aspect of a motor according to the fourth invention, the motor includes:

a magnet including a plurality of magnetic poles;

a plurality of slots opposing the magnet;

a coil wound around each of the plurality of slots;

a commutator including a plurality of segments; and

a plurality of brushes, each of the plurality of brushes including a contact portion contacting two or more adjacent segments among the plurality of segments, wherein

both ends of the coil are connected to two segments among the plurality of segments,

one end of another coil is connected to a segment adjacent to the other side of a segment arranged on one side of two segments connected to the coil in a circumferential direction of the commutator,

one end of other further another coil is connected to a segment adjacent to one side of the segment on the other side of two segments connected to the coil in the circumferential direction of the commutator,

a segment not connected to any of the coils is adjacent to one side and the other side of two adjacent segments connected to either of the coils in the circumferential direction of the commutator, and

in the circumferential direction of the commutator, the segments in a rotationally symmetrical positional relationship have the same potential.

As one aspect of a motor according to the fifth invention, the motor includes:

a magnet including a plurality of magnetic poles;

a plurality of slots opposing the magnet;

a coil wound around each of the plurality of slots;

a commutator including a plurality of segments; and

a plurality of brushes, each of the plurality of brushes including a contact portion contacting two adjacent segments among the plurality of segments, wherein

one end of the coil is connected to one segment among the plurality of segments, the other end of the coil is connected to one end of another coil in an n-fold symmetrical positional relationship in a circumferential direction of the commutator, and the other end of

the another coil is connected to another segment among the plurality of segments, in the circumferential direction of the commutator, one end of the coil adjacent to one side of the coil is connected to the segment as a second segment from one side of the one segment,

the other end of the coil is connected to one end of further another coil in a rotationally symmetrical positional relationship, and the other end of the further another coil is connected to the segment as the second segment from one side of the another segment,

the segment between the segment connected to one end of the coil and the segment connected to one end of the coil adjacent to one side of the coil is not connected to any coil,

the segment between the segment connected to the other end of the another coil and the segment connected to the other end of the coil adjacent to one side of the another coil is not connected to any coil, and

in the circumferential direction of the commutator, the segments in the positional relationship of 2n-fold symmetry have the same potential.

### BRIEF DESCRIPTION OF THE DRAWINGS

FIG. 1 is an exploded perspective view of a motor according to an embodiment as an example of a first invention.

FIG. 2 is a schematic diagram formed by developing each component of an armature arranged in a circumferential direction in a left-right direction, and showing a mutual relationship (positional relationship, connection relationship) in the motor according to a first embodiment as an example of the first invention.

FIG. 3 is a schematic cross-sectional view taken along a plane perpendicular to an axial direction of a shaft 8 in a portion where a commutator 4 and a plurality of brushes 7 are in contact with each other in FIG. 1.

FIG. 4 is an illustrative diagram for illustrating a change in a magnetic pole of a slot and a movement of components of the armature in time series when a predetermined current or voltage is applied to the motor according to the first embodiment, and is first half (1) to (3) in time series.

FIG. 5 is an illustrative diagram for illustrating the change in the magnetic pole of the slot and the movement of the components of the armature in time series when the predetermined current or voltage is applied to the motor according to the first embodiment, and is second half (4) to (6) in time series.

FIG. 6 is a schematic diagram formed by developing each component of an armature arranged in a circumferential direction in a left-right direction, and showing a mutual relationship (positional relationship, connection relationship) in a motor according to a second embodiment as an example of the first invention.

FIG. 7 is an illustrative diagram for illustrating a change in a magnetic pole of a slot and a movement of components of the armature in time series when a predetermined current or voltage is applied to the motor according to the second embodiment, and is first half (1) to (3) in time series.

FIG. 8 is an illustrative diagram for illustrating the change in the magnetic pole of the slot and the movement of the components of the armature in time series when the predetermined current or voltage is applied to the motor according to the second embodiment, and is second half (4) to (6) in time series.

FIG. 9 is a schematic diagram formed by developing each component of an armature arranged in a circumferential direction in a left-right direction, and showing a mutual relationship (positional relationship, connection relationship) in a motor according to a third embodiment as an example of the first invention.

FIG. 10 is an illustrative diagram for illustrating a change in a magnetic pole of a slot and a movement of components of the armature in time series when a predetermined current or voltage is applied to the motor according to the third embodiment, and is a first part (1) to (3) in time series.

FIG. 11 is an illustrative diagram for illustrating the change in the magnetic pole of the slot and the movement of the components of the armature in time series when the predetermined current or voltage is applied to the motor according to the third embodiment, and is a middle part (4) and (5) in time series.

FIG. 12 is an illustrative diagram for illustrating the change in the magnetic pole of the slot and the movement of the components of the armature in time series when the predetermined current or voltage is applied to the motor according to the third embodiment, and is a third part (6) and (7) in time series.

FIG. 13 is a schematic diagram formed by developing each component of an armature arranged in a circumferential direction in a left-right direction, and showing a mutual relationship (positional relationship, connection relationship) in a motor according to a fourth embodiment as an example of the first invention.

FIG. 14 is an illustrative diagram for illustrating a change in a magnetic pole of a slot and a movement of components of the armature in time series when a predetermined current or voltage is applied to the motor according to the fourth embodiment, and is first half (1) to (3) in time series.

FIG. 15 is an illustrative diagram for illustrating the change in the magnetic pole of the slot and the movement of the components of the armature in time series when the predetermined current or voltage is applied to the motor according to the fourth embodiment, and is second half (4) and (5) in the time series.

FIG. 16 is a schematic diagram formed by developing each component of an armature arranged in a circumferential direction in a left-right direction, and showing a mutual relationship (positional relationship, connection relationship) in a motor according to a fifth embodiment as an example of a second invention.

FIG. 17 is an illustrative diagram for illustrating a change in a magnetic pole of a slot and a movement of components of the armature in time series when a predetermined current or voltage is applied to the motor according to the fifth embodiment, and is first half (1) to (3) in time series.

FIG. 18 is an illustrative diagram for illustrating the change in the magnetic pole of the slot and the movement of the components of the armature in time series when the predetermined current or voltage is applied to the motor according to the fourth embodiment, and is second half (4) to (6) in time series.

FIG. 19 is a schematic diagram formed by developing each component of an armature arranged in a circumferential direction in a left-right direction, and showing a mutual relationship (positional relationship, connection relationship) in a motor according to a sixth embodiment as an example of the second invention.

FIG. 20 is an illustrative diagram for illustrating a change in a magnetic pole of a slot and a movement of components of the armature in time series when a predetermined current or voltage is applied to the motor according to the sixth embodiment, and is first half (1) to (3) in time series.

FIG. 21 is an illustrative diagram for illustrating the change in the magnetic pole of the slot and the movement of the components of the armature in time series when the predetermined current or voltage is applied to the motor according to the sixth embodiment, and is second half (4) and (5) in time series.

FIG. 22 is a schematic diagram formed by developing each component of an armature arranged in a circumferential direction in a left-right direction, and showing a mutual relationship (positional relationship, connection relationship) in a motor according to a seventh embodiment as an example of the second invention.

FIG. 23 is a schematic diagram formed by developing each component of an armature arranged in a circumferential direction in a left-right direction, and showing a mutual relationship (positional relationship, connection relationship) in a motor according to an eighth embodiment as an example of a third invention.

FIG. 24 is an illustrative diagram for illustrating a change in a magnetic pole of a slot and a movement of components of the armature in time series when a predetermined current or voltage is applied to the motor according to the eighth embodiment, and is a first part (1) to (3) in time series.

FIG. 25 is an illustrative diagram for illustrating the change in the magnetic pole of the slot and the movement of the components of the armature in time series when the predetermined current or voltage is applied to the motor according to the eighth embodiment, and is a middle part (4) to (6) in time series.

FIG. 26 is an illustrative diagram for illustrating the change in the magnetic pole of the slot and the movement of the components of the armature in time series when the predetermined current or voltage is applied to the motor according to the eighth embodiment, and is a third part (7) and (8) in time series.

FIG. 27 is a schematic diagram formed by developing each component of an armature arranged in a circumferential direction in a left-right direction, and showing a mutual relationship (positional relationship, connection relationship) in a motor according to a ninth embodiment as an example of a fourth invention.

FIG. 28 is a schematic diagram formed by developing each component of an armature arranged in a circumferential direction in a left-right direction, and showing a mutual relationship (positional relationship, connection relationship) in a motor according to a tenth embodiment as an example of the fourth invention.

FIG. 29 is a schematic diagram formed by developing each component of an armature arranged in a circumferential direction in a left-right direction, and showing a mutual relationship (positional relationship, connection relationship) in a motor according to an 11th embodiment as an example of a fifth invention.

FIG. 30 is a schematic diagram formed by developing each component of an armature arranged in a circumferential direction in a left-right direction, and showing a mutual relationship (positional relationship, connection relationship) in a motor according to a twelfth embodiment as an example of the fifth invention.

### DESCRIPTION OF THE PREFERRED EMBODIMENTS

Hereinafter, embodiments of the invention will be described by dividing the invention into first to fifth inventions.

### [First Invention]

A motor according to a first invention includes:

a magnet including a plurality of magnetic poles;

a plurality of slots opposing the magnet;

a coil wound around each of the plurality of slots;

a commutator including a plurality of segments; and

a plurality of brushes, each of the plurality of brushes including a contact portion contacting two adjacent segments among the plurality of segments, wherein

both ends of the coil are connected to the two segments among the plurality of segments, and another segment is arranged between the two segments,

one ends of two adjacent coils are connected to one segment of the two segments, and

a segment connected to one ends of two adjacent coils and the another segment between two segments connected to either coil different from the two adjacent coils have the same potential.

Hereinafter, first to fourth embodiments as exemplary aspects of the first invention will be described with reference to the drawings.

### First Embodiment

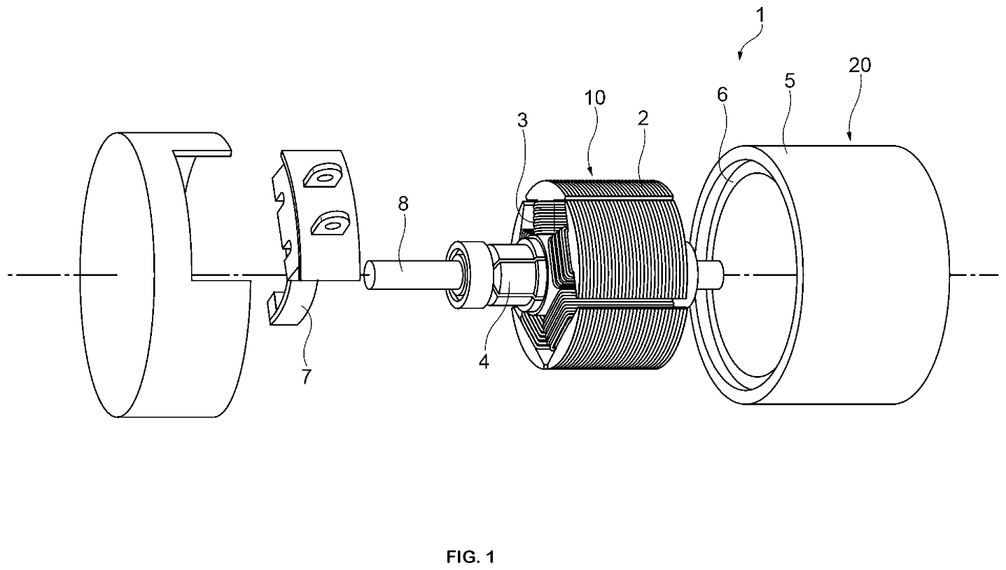

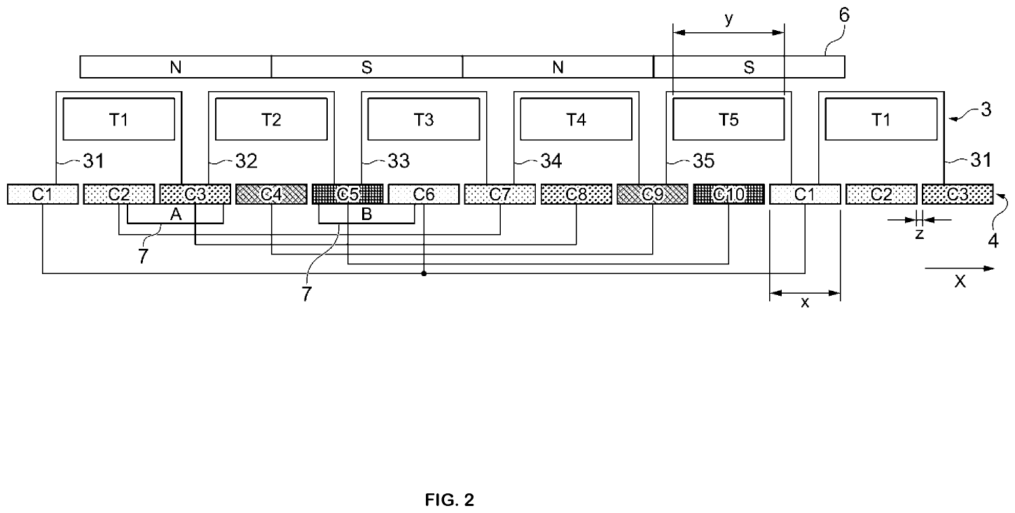

FIG. 1 is an exploded perspective view of a motor 1 according to the first embodiment as an example of the first invention. FIG. 2 is a schematic diagram formed by developing each component of an armature arranged in a circumferential direction in a left-right direction, and showing a mutual relationship (positional relationship, connection relationship) in the motor 1.

In FIG. 2, lower solid lines indicate connection wiring. A point of intersection of a cross indicates a non-connection state. A point where a black dot overlaps a point of intersection of a T shape indicates a connection state. The same applies to the display of the connection wiring in the subsequent similar schematic diagrams and illustrative diagrams including other embodiments and the like.

As shown in FIG. 1, the motor 1 according to the present embodiment is a 4-pole 5-slot motor including an armature 10 on a ratating side fixed to the shaft 8 and rotated together with the shaft 8, and a stator 20 on a fixed side. In the motor 1, the armature 10 includes a rotor core 2 including a plurality of (five, which is an odd number, in the present embodiment) slots (magnetic pole portions), coils 3 wound around the respective slots, and a commutator 4 including a plurality of (ten in the present embodiment) segments. Meanwhile, the stator 20 includes a housing 5, a magnet 6 including a plurality of magnetic poles (four, which is an even number, in the present embodiment), and a plurality of brushes 7 contacting the segments of the commutator 4.

As shown in FIG. 2, a rotor core 2 includes first tooth T1 to fifth tooth T5 as a plurality of (five in the present embodiment) slots arranged in the circumferential direction. Coils 31 to 35 are wound around the first tooth T1 to the fifth tooth T5, respectively. The coils 31 to 35 have the same number of turns and the same winding axis direction (spiral direction).

The commutator 4 has segments C1 to C10 as the plurality of segments arranged in the circumferential direction. The segments C1 to C10 are brought into contact with contact portions A and B of the plurality of brushes 7 and energized.

The housing 5 accommodates the armature 10 and also functions as a yoke by being made of a magnetic body (ferromagnetic body) such as iron.

The magnet 6 has a cylindrical shape provided at an inner surface of the housing 5. In the present embodiment, N poles and S poles are alternately magnetized in the circumferential direction to form a permanent magnet having four magnetic poles. The first tooth T1 to the fifth tooth T5 as slots face an inner circumferential surface of the magnet 6.

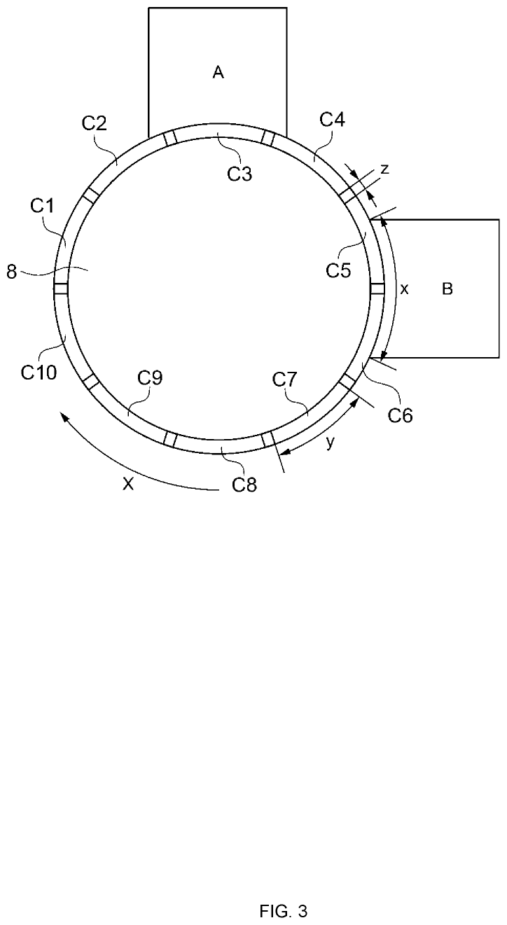

FIG. 3 is a schematic cross-sectional view taken along a plane perpendicular to an axial direction of the shaft 8 in a portion where the commutator 4 and the plurality of brushes 7 are in contact with each other. The plurality of brushes 7 have the contact portions A and B. The contact portion A and the contact portion B are disposed at positions where a central angle about an axis of the shaft 8 is 90°, and are in contact with the commutator 4. The shaft 8 and the commutator 4 rotate in an arrow X direction.

As shown in FIG. 3, when a width of the contact portions A and B of the plurality of brushes 7 with the commutator 4 in the circumferential direction of the commutator 4 (arrow X direction) is x, a width of the segments (C1 to C10) in the commutator 4 is y, and a gap between two adjacent segments is z, the following relational expression (1) is satisfied in the present embodiment.

2y+3z>x>y+2z relational expression (1)

By satisfying the relational expression (1), as shown in FIG. 3, since the contact portions A and B of the plurality of brushes 7 always come into contact with two or more adjacent segments (x>y+2z), and the brushes do not come into contact with four or more segments at the same time (2y+3z>x), short circuit can be prevented.

By satisfying the following relational expression (1′), when the contact portions A and B are each in contact with the two segments, both sides of each of the contact portions A and B in the circumferential direction may be prevented from protruding from the segments.

2y+z>x>y+2z relational expression (1′)

In the present embodiment, both ends of each coil 3 are connected to two segments of the plurality of segments C1 to C10. Another segment not connected to both ends of the coil 3 is arranged between these two segments.

In FIG. 2, when the first coil 31 is described as an example, first, both ends of the first coil 31 are connected to two segments C1 and C3. Then, another segment C2 not connected to both ends of the first coil 31 is arranged between the two segments C1 and C3.

A relationship between the segments and the coil described above is the same for the remaining second coil 32 to the fifth coil 35.

In the following description in the first invention, a segment such as the segment C2 located between two segments directly connected to both ends of the coil 3 may be referred to as an “intermediate segment”. In the present embodiment, in addition to the segment C2, a total of five segments C4, C6, C8, and C10 correspond to the “intermediate segments”.

In the following description in the first invention, segments such as the segments C1 and C3 directly connected to both ends of the coil 3 may be referred to as “connection segments”. In the present embodiment, in addition to the segments C1 and C3, a total of five segments C5, C7, and C9 correspond to the “connection segments”.

In the present embodiment, one ends of two adjacent coils are connected to one segment of the two segments (the connection segments connected to both ends of the coil 3).

In FIG. 2, when the first coil 31 and the second coil 32 adjacent to the first coil 31 are described as an example, one ends of the first coil 31 and the second coil 32 are connected to one segment (C3) of the connection segments C1 and C3 connected to both ends of the first coil 31.

Other adjacent relationships of the first coil 31 to the fifth coil 35 are similar to the relationship between the segments and the coils described above.

In the present embodiment, the connection segment connected to one ends of two adjacent coils and the intermediate segment between the two connection segments connected to either coil different from the two coils have the same potential.

In FIG. 2, when the connection segment C3 connected to one ends of the first coil 31 and the second coil 32 adjacent to the first coil 31 is described as an example, the connection segment C3 and the intermediate segment C8 between two connection segments C7 and C9 connected to the fourth coil 34 different from the two coils 31 and 32 are connected. Therefore, the connection segment C3 and the intermediate segment C8 have the same potential.

Other relationships between the segments in the segments C1 to C10 are similar to the relationship between the segments described above.

In the present embodiment, a position of the connection segment and a position of the other intermediate segment having the same potential as the potential of the connection segment in the circumferential direction of the commutator 4 (arrow X direction) have a rotationally symmetrical positional relationship.

In FIG. 2, when the connection segment C3 is described as an example, the position of the connection segment C3 and the position of the intermediate segment C8 having the same potential as the potential of the connection segment C3 in the circumferential direction of the commutator 4 (arrow X direction) have a rotationally symmetrical (specifically, two-fold symmetrical) positional relationship.

Other relationships between the segments having the same potential in the segments C1 to C10 are similar to the relationship between the segments described above.

An operation of the motor 1 according to the present embodiment will be described.

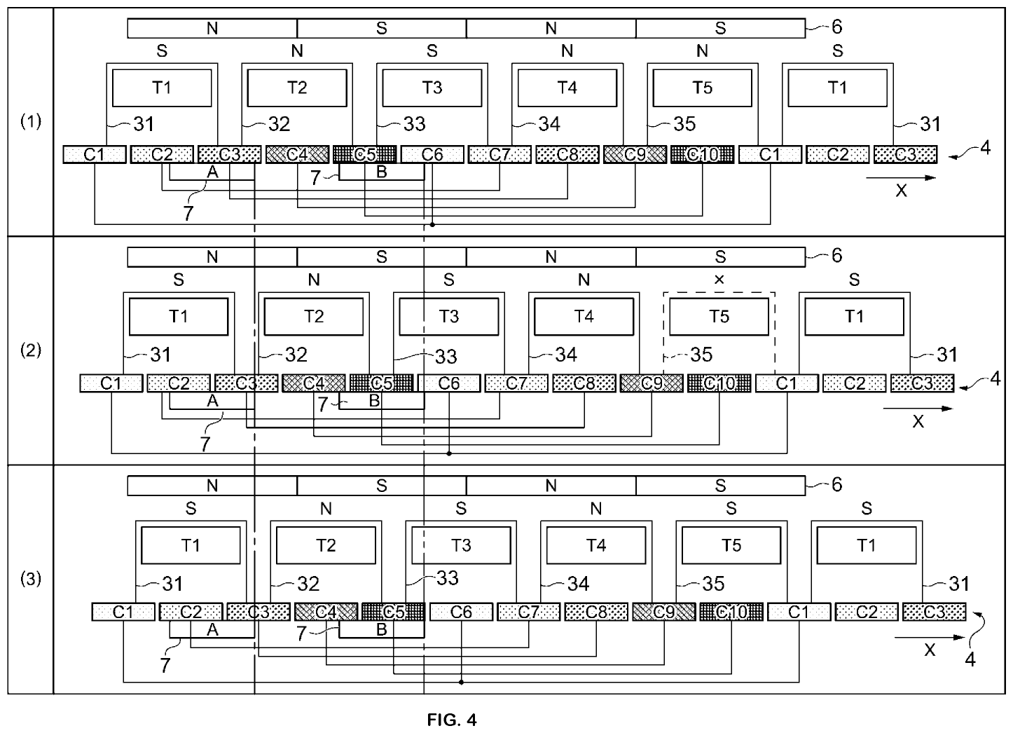

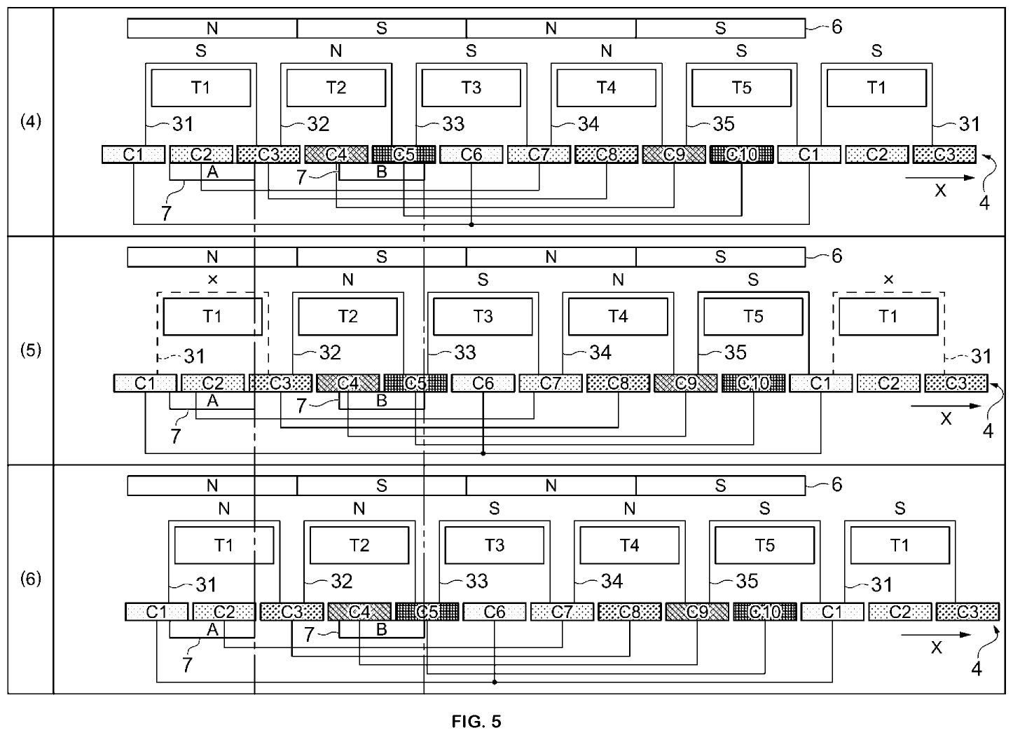

FIGS. 4 and 5 are illustrative diagrams for illustrating a change in a magnetic pole of the slots and a movement of components of the armature 10 in time series when a predetermined current or voltage is applied to the motor 1 according to the present embodiment. Similarly to the schematic diagram in FIG. 2, each diagram of (1) to (3) in FIG. 4 and (4) to (6) in FIG. 5 is obtained by developing each component of the armature 10 arranged in the circumferential direction in a left-right direction, and showing a mutual relationship (positional relationship, connection relationship).

FIGS. 4 and 5 illustrate a state of the teeth T1 to T5 as the components of the armature 10 sequentially moving in the arrow X direction from (1) in FIG. 4 to (6) in FIG. 5 with the lapse of time, and a contact state (energization state) between the contact portions A and B of the plurality of brushes 7 and the segments C1 to C10 is switched. In order to facilitate understanding of the positional relationship between the contact portions A and B of the plurality of brushes 7 and the teeth T1 to T5 and the like, in FIGS. 4 and 5, a one-dot chain line is attached to a right end of the contact portion A and a two-dot chain line is attached to a right end of the contact portion B as auxiliary lines over each time series.

Symbols between the magnet 6 and the teeth T1 to T5 in (1) to (6) in FIGS. 4 and 5 represent magnetic poles (N poles or S poles) of the teeth T1 to T5 in each state. Note that no voltage is applied and no magnetic field is generated in a place marked with x. The symbols in these places are applied to the illustrative diagrams in the following other embodiments (including embodiments of the second to fifth inventions and a modification).

First, in the state of FIG. 4(1), a predetermined DC voltage is applied to the contact portions A and B of the plurality of brushes 7 (in the present embodiment, the contact portion A is positive and the contact portion B is negative). In the state of FIG. 4(1), the contact portions A of the plurality of brushes 7 are in contact with the segments C2 and C3 of the commutator 4, and the contact portions B of the plurality of brushes 7 are in contact with the segments C5 and C6.

The applied voltage is applied to each of the first to fifth coils 31 to 35 via each connection wiring according to the contact state between the plurality of brushes 7 and the commutator 4, and a current whose positive and negative directions are selected flows. Then, as shown in FIG. 4(1), the magnetic poles of the teeth T1 to T5 are the S pole, the N pole, the S pole, the N pole, and the N pole in this order (hereinafter, abbreviated as “the magnetic poles of the teeth T1 to T5 are SNSNN”).

Due to an interaction caused by an attractive force or a repulsive force between the magnetic poles of the teeth T1 to T5 and the magnetic poles of the magnet 6, the teeth (slots) T1 to T5 as the components of the armature 10 the first to fifth coils 31 to 35, and the segments C1 to C10 (hereinafter, may be referred to as “commutator 4 or the like”) move in the arrow X direction, and the shaft 8 rotates.

When the commutator 4 and the like move to the state of FIG. 4(2), the contact portion A of one brush 7 remains in contact with the segments C2 and C3, and the contact portion B of the other brush 7 is in contact with the segments C4, C5, and C6. Due to the change in the contact state between the plurality of brushes 7 and the commutator 4, the positive and negative directions of the currents flowing through the first to fifth coils 31 to 35 are also changed. As shown in FIG. 4(2), the magnetic poles of the teeth T1 to T4 become the S pole, the N pole, the S pole, and the N pole in order, and the current does not flow through the tooth T5 and the magnetic field is not generated (symbol x) (hereinafter, abbreviated as “the magnetic poles of the teeth T1 to T5 are SNSNx”).

Due to the interaction between the magnetic poles of the teeth T1 to T5 and the magnetic poles of the magnet 6 due to the attractive force or the repulsive force, the commutator 4 and the like move in the arrow X direction, and the rotation of the shaft 8 is maintained.

When the commutator 4 and the like move to the state of FIG. 4(3), the contact portion A of one brush 7 remains in contact with the segments C2 and C3, and the contact portion B of the other brush 7 is in contact with the segments C4 and C5. Due to the change in the contact state between the plurality of brushes 7 and the commutator 4, the positive and negative directions of the currents flowing through the first to fifth coils 31 to 35 also change. As shown in FIG. 4(3), the magnetic poles of the teeth T1 to T5 are SNSNS.

Due to the interaction between the magnetic poles of the teeth T1 to T5 and the magnetic poles of the magnet 6 due to the attractive force or the repulsive force, the commutator 4 and the like move in the arrow X direction, and the rotation of the shaft 8 is maintained.

Next, although the commutator 4 and the like move to the state shown in FIG. 5(4), the contact state between the commutator 4 and the contact portions A and B of the plurality of brushes 7 is not different from the state shown in FIG. 4(3). Therefore, also in the state of FIG. 5(4), similarly to the state of FIG. 4(3), due to the interaction between the magnetic poles of the teeth T1 to T5 and the magnetic poles of the magnet 6 due to the attractive force or the repulsive force, the commutator 4 and the like move in the arrow X direction, and the rotation of the shaft 8 is maintained.

Further, when the commutator 4 and the like move to the state of FIG. 5(5), the contact portion A of one brush 7 comes into contact with the segments C1, C2, and C3, and the contact portion B of the other brush 7 remains in contact with the segments C4 and C5. Due to the change in the contact state between the plurality of brushes 7 and the commutator 4, the positive and negative directions of the currents flowing through the first to fifth coils 31 to 35 also change. As shown in FIG. 5(5), the magnetic poles of the teeth T1 to T5 are ×NSNS.

Due to the interaction between the magnetic poles of the teeth T1 to T5 and the magnetic poles of the magnet 6 due to the attractive force or the repulsive force, the commutator 4 and the like move in the arrow X direction, and the rotation of the shaft 8 is maintained.

When the commutator 4 and the like move to the state of FIG. 5(6), the contact portion A of one brush 7 comes into contact with the segments C1 and C2, and the contact portion B of the other brush 7 remains in contact with the segments C4 and C5. Due to the change in the contact state between the plurality of brushes 7 and the commutator 4, the positive and negative directions of the currents flowing through the first to fifth coils 31 to 35 also change. As shown in FIG. 5(6), the magnetic poles of the teeth T1 to T5 are NNSNS.

Due to the interaction between the magnetic poles of the teeth T1 to T5 and the magnetic poles of the magnet 6 due to the attractive force or the repulsive force, the commutator 4 and the like move in the arrow X direction, and the rotation of the shaft 8 is maintained.

In the motor 1 according to the present embodiment, by applying the predetermined current or voltage to the plurality of brushes 7, the rotation of the commutator 4 and the like in the arrow X direction is maintained as illustrated in the time series of (1) to (6) in FIGS. 4 and 5. The rotation of the motor is continued by further continuing the rotation.

According to the motor 1 in the present embodiment, the contact portions A and B of the plurality of brushes 7 are in contact with two or more adjacent segments at the same time. Therefore, since the width x of the contact portions A and B is wide, it is possible to smoothly extend over the slit (gap between adjacent segments) of the commutator 4. Therefore, according to the motor 1 in the present embodiment, since the plurality of brushes 7 are less likely to be shaken, it is possible to reduce noise caused by the shaking of the plurality of brushes 7.

According to the motor 1 in the present embodiment, in a connection method at the time of assembling the armature 10, since the width x of the contact portions A and B of the plurality of brushes 7 is wide, it is possible to improve energization efficiency and reliability (in particular, to improve the life of the motor).

Although the commutator has ten segments, the width x of the contact portions A and B of the plurality of brushes 7 can be widened, so that the number of slots can be reduced to five, and the space for the winding can be easily ensured. Since it is easy to ensure a space for the winding, a space factor can be improved. As a result, the size of the motor can be reduced and torque can be increased.

In the motor 1 in the present embodiment, since the coils 3 are concentrated winding and a winding portion can be made thinner than overlapping winding, the number of stacked magnetic bodies (electrical steel plates) constituting the rotor core 2 having the slots can be increased, and magnetic efficiency can be improved.

In the motor 1 in the present embodiment, when an improvement state of cogging torque with respect to the 4-pole 10-slot motor including the coils wound in an overlapping manner is confirmed, it is possible to confirm an improvement of 10% or more of a load fluctuation rate. Therefore, according to the motor 1 in the present embodiment, it can be seen that the cogging torque can be reduced.

### Second Embodiment

A motor according to a second embodiment as an example of the first invention will be described. The motor according to the second embodiment is different from the motor 1 according to the first embodiment in the configuration of the armature. Specifically, in the present embodiment, the number of slots of the rotor core 2 is seven, and the number of segments of the commutator 4 is 14.

As described above, although the shape of the armature is slightly different, other configurations are the same as the configurations of the first embodiment. Therefore, for an overall configuration of the motor according to the present embodiment, please refer to FIG. 1 representing the motor 1 according to the first embodiment. The same reference numerals as those in the first embodiment are used for the reference numerals. For a large number of teeth, coils and segments, new reference numerals will only be given to numerals of excess parts.

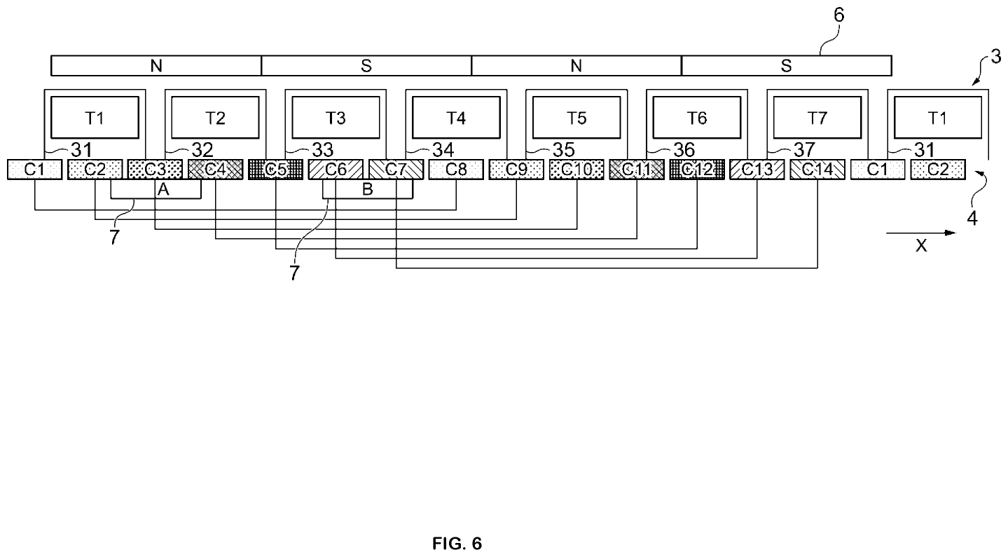

FIG. 6 is a schematic diagram formed by developing each component of the armature arranged in the circumferential direction in the left-right direction, and showing a mutual relationship (positional relationship, connection relationship) in the motor according to the second embodiment as an example of the first invention.

As shown in FIG. 6, the rotor core 2 includes the first tooth T1 to seventh tooth T7 as a plurality of slots (seven in the present embodiment) arranged in the circumferential direction. Coils 31 to 37 are wound around the first tooth T1 to the seventh tooth T7, respectively. The coils 31 to 37 have the same number of turns and the same winding axis direction (spiral direction).

The commutator 4 has segments C1 to C14 as the plurality of segments arranged in the circumferential direction. The segments C1 to C14 are brought into contact with contact portions A and B of the plurality of brushes 7 and energized.

A size relationship between the contact portions A and B of the plurality of brushes 7 and the segments (C1 to C14) in the commutator 4 satisfies the above-described relational expression (1).

In the present embodiment, both ends of each coil 3 are connected to two segments (connection segments) among the plurality of segments C1 to C14, and another segment (intermediate segment) is arranged between the two segments. Both ends of the coil 3 are not connected to the another segment (intermediate segment).

In FIG. 6, the sixth coil 36 is described as an example. First, both ends of the sixth coil 36 are connected to two connection segments C11 and C13. Then, another intermediate segment C12 is arranged between the two connection segments C11 and C13. Both ends of the coil 3 are not connected to the intermediate segment C12.

A relationship between the segments and the coil described above is the same for the remaining first coil 31 to the fifth coil 35 and the seventh coil 37.

In the present embodiment, one ends of two adjacent coils are connected to one segment of the two segments (the connection segments connected to both ends of the coil 3).

In FIG. 6, when the sixth coil 36 and the seventh coil 37 adjacent to the sixth coil 36 are described as an example, one ends of the sixth coil 36 and the seventh coil 37 are connected to one segment (C13) of the connection segments C11 and C13 connected to both ends of the sixth coil 36.

Other adjacent relationships of the first coil 31 to the seventh coil 37 are similar to the relationship between the segments and the coils described above.

In the present embodiment, the connection segment connected to one ends of two adjacent coils and the intermediate segment between the two connection segments connected to either coil different from the two coils have the same potential.

In FIG. 6, when the connection segment C13 connected to one ends of the sixth coil 36 and the seventh coil 37 adjacent to the sixth coil 36 is described as an example, the connection segment C13 and an intermediate segment C6 between two connection segments C5 and C7 connected to the third coil 33 different from the two coils 36 and 37 are connected. Therefore, the connection segment C13 and the intermediate segment C6 have the same potential.

Other relationships between the segments in the segments C1 to C14 are similar to the relationship between the segments described above.

In the present embodiment, a position of the connection segment and a position of the other intermediate segment having the same potential as the potential of the connection segment in the circumferential direction of the commutator 4 (arrow X direction) have a rotationally symmetrical positional relationship.

In FIG. 6, when the connection segment C13 is described as an example, the position of the connection segment C13 and the position of the intermediate segment C6 having the same potential as the potential of the connection segment C13 in the circumferential direction of the commutator 4 (arrow X direction) have the rotationally symmetrical (specifically, two-fold symmetrical) positional relationship.

Other relationships between the segments having the same potential in the segments C1 to C14 are similar to the relationship between the segments described above.

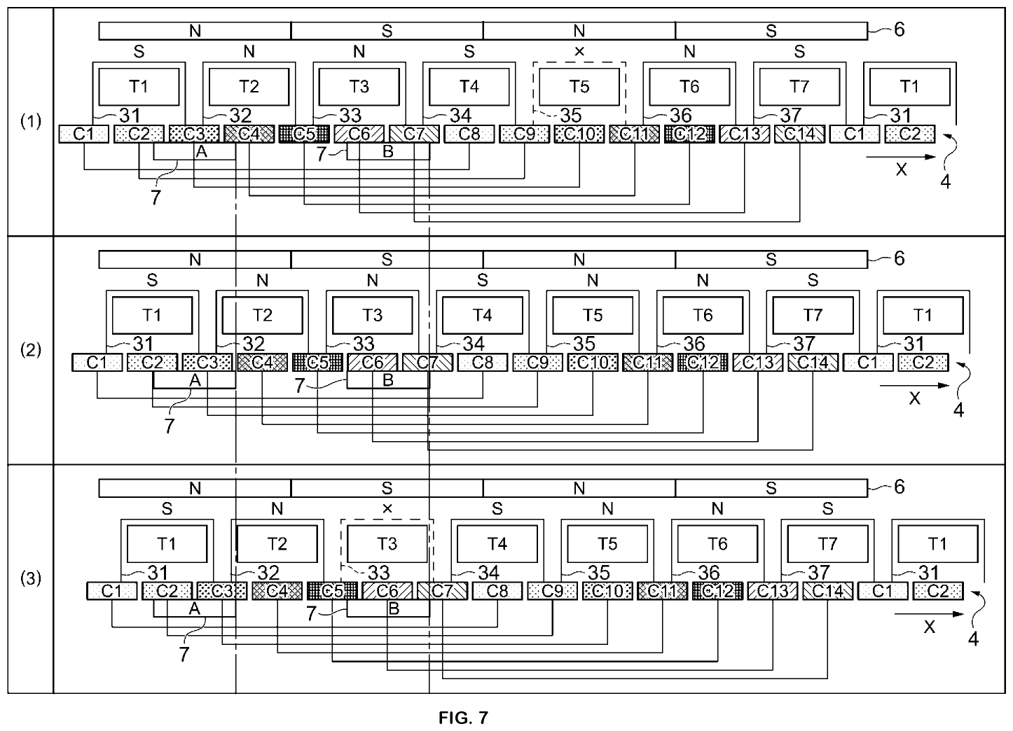

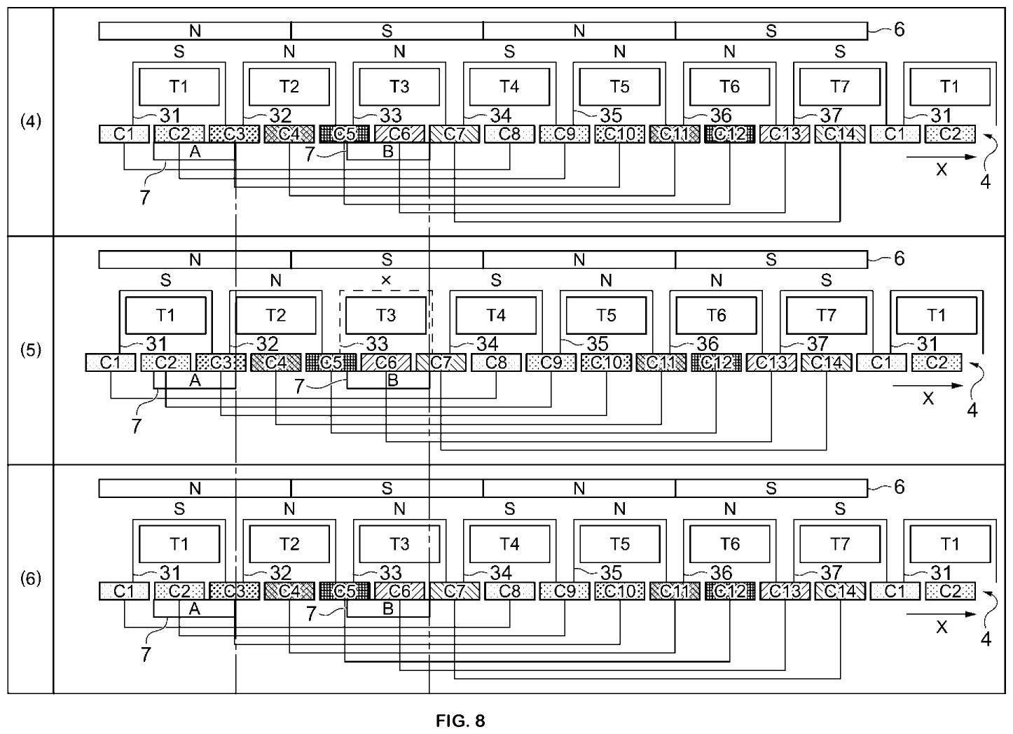

Regarding the operation of the motor according to the present embodiment, the illustrative diagrams similar to FIGS. 4 and 5 in the first embodiment are also presented in the present embodiment as FIGS. 7 and 8, and the detailed description thereof will be omitted.

FIGS. 7 and 8 are illustrative diagrams for illustrating a change in a magnetic pole of the slots and a movement of components of the armature 10 in time series when a predetermined current or voltage is applied to the motor according to the present embodiment. Similarly to the schematic diagram in FIG. 6, each diagram of (1) to (3) in FIG. 7 and (4) to (6) in FIG. 8 is obtained by developing each component of the armature 10 arranged in the circumferential direction in a left-right direction, and showing a mutual relationship (positional relationship, connection relationship).

FIGS. 7 and 8 illustrate a state of the teeth T1 to T7 as the components of the armature 10 sequentially moving in the arrow X direction from (1) in FIG. 7 to (6) in FIG. 8 with the lapse of time, and a contact state (energization state) between the contact portions A and B of the plurality of brushes 7 and the segments C1 to C14 is switched.

Also in the motor according to the present embodiment, as in the case of the first embodiment, in accordance with the change in the contact state between the plurality of brushes 7 and the commutator 4, the current whose positive and negative directions are selected flows through the first to seventh coils 31 to 37 via each connection wiring. As a result, as illustrated in (1) to (3) in FIG. 7 and (4) to (6) in FIG. 8, the teeth T1 to T7 indicate respective magnetic poles. Due to the interaction between the magnetic poles of the teeth T1 to T7 and the magnetic poles of the magnet 6 due to the attractive force or the repulsive force, the commutator 4 and the like move in the arrow X direction, and the rotation of the shaft 8 is maintained.

In the motor according to the present embodiment, by applying the predetermined current or voltage to the plurality of brushes 7, the rotation of the commutator 4 and the like in the arrow X direction is maintained as illustrated in the time series of (1) to (6) in FIGS. 7 and 8. The rotation of the motor is continued by further continuing applying the predetermined current or voltage to the plurality of brushes.

According to the motor in the present embodiment, the contact portions A and B of the plurality of brushes 7 are in contact with two or more adjacent segments at the same time. Therefore, since the width x of the contact portions A and B is wide, it is possible to smoothly extend over the slit (gap between adjacent segments) of the commutator 4. Therefore, according to the motor in the present embodiment, since the plurality of brushes 7 are less likely to be shaken, it is possible to reduce noise caused by the shaking of the plurality of brushes 7.

According to the motor in the present embodiment, in a connection method at the time of assembling the armature 10, since the width x of the contact portions A and B of the plurality of brushes 7 is wide, it is possible to improve the energization efficiency and the reliability (in particular, to improve the life of the motor).

Although the commutator has 14 segments, the width x of the contact portions A and B of the plurality of brushes 7 can be widened, so that the number of slots can be reduced to seven, and the space for the winding can be easily ensured. Since it is easy to ensure a space for the winding, a space factor can be improved. As a result, the size of the motor can be reduced and the torque can be increased.

In the motor in the present embodiment, since the coils 3 are concentrated winding and a winding portion can be made thinner than overlapping winding, the number of stacked magnetic bodies (electrical steel plates) constituting the rotor core 2 having the slots can be increased, and magnetic efficiency can be increased.

In the motor in the present embodiment, when the improvement state of the cogging torque with respect to the 4-pole 14-slot motor including the coils wound in the overlapping manner is confirmed, it can be confirmed that the load fluctuation rate is increased. Therefore, according to the motor in the present embodiment, it can be seen that the cogging torque can be reduced.

### Third Embodiment

A motor according to a third embodiment as an example of the first invention will be described. The motor according to the third embodiment is different from the motor 1 according to the first embodiment in the configurations of the magnet and the armature. Specifically, in the present embodiment, the number of magnetic poles of the magnet 6 is six, the number of slots of the rotor core 2 is seven, and the number of segments of the commutator 4 is 21.

As described above, although the shape of the armature is slightly different, an appearance of the magnet is cylindrical and does not change, and other configurations are the same as the configurations of the first embodiment. Therefore, for the overall configuration of the motor according to the present embodiment, please refer to FIG. 1 representing the motor 1 according to the first embodiment. The same reference numerals as those in the first embodiment are used for the reference numerals. For a large number of teeth, coils and segments, new reference numerals will only be given to numerals of excess parts.

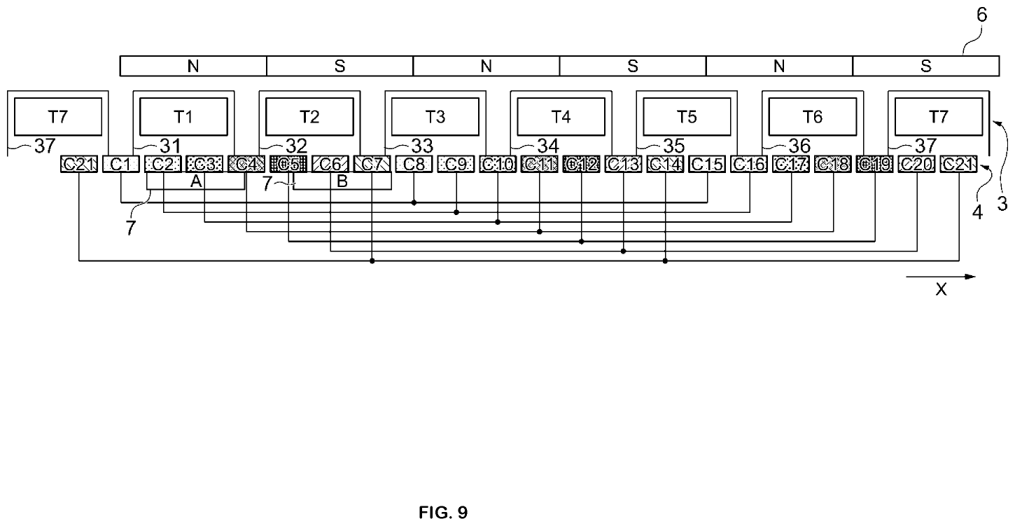

FIG. 9 is a schematic diagram formed by developing each component of the armature arranged in the circumferential direction in the left-right direction, and showing a mutual relationship (positional relationship, connection relationship) in the motor according to the third embodiment as an example of the first invention.

As shown in FIG. 9, the rotor core 2 includes the first tooth T1 to the seventh tooth T7 as a plurality of slots (seven in the present embodiment) arranged in the circumferential direction. The coils 31 to 37 are wound around the first tooth T1 to the seventh tooth T7, respectively. The coils 31 to 37 have the same number of turns and the same winding axis direction (spiral direction).

The commutator 4 has segments C1 to C21 as the plurality of segments arranged in the circumferential direction. The segments C1 to C21 are brought into contact with contact portions A and B of the plurality of brushes 7 and energized.

A size relationship between the contact portions A and B of the plurality of brushes 7 and the segments (C1 to C21) in the commutator 4 satisfies the following relational expression (2).

3y+4z>x>2y+3z relational expression (2)

By satisfying the relational expression (2), since the contact portions A and B of the plurality of brushes 7 always come into contact with three or more adjacent segments (x>2y+3z), and the brushes do not come into contact with five or more segments at the same time (3y+4z>x), the short circuit can be prevented.

By satisfying the following relational expression (2′), when the contact portions A and B are each in contact with three segments, both sides of each of the contact portions A and B in the circumferential direction may be prevented from protruding from the segments at the same time.

3y+2z>x>2y+3z relational expression (2′)

In the present embodiment, both ends of each coil 3 are connected to two segments (connection segments) among the plurality of segments C1 to C21, and another segment (intermediate segment) is arranged between the two segments. Both ends of the coil 3 are not connected to the another segment (intermediate segment).

In FIG. 9, the first coil 31 is described as an example. First, both ends of the first coil 31 are connected to two connection segments C1 and C4. Then, other intermediate segments C2 and C3 are arranged between the two connection segments C1 and C4. Both ends of the coil 3 are not connected to the another intermediate segments C2 and C3.

A relationship between the segments and the coil described above is the same for the remaining second coil 32 to the seventh coil 37.

In the present embodiment, one ends of two adjacent coils are connected to one segment of the two segments (the connection segments connected to both ends of the coil 3).

In FIG. 9, when the first coil 31 and the second coil 32 adjacent to the first coil 31 are described as an example, one ends of the first coil 31 and the second coil 32 are connected to one segment (C4) of the connection segments C1 and C4 connected to both ends of the first coil 31.

Other adjacent relationships of the first coil 31 to the seventh coil 37 are similar to the relationship between the segments and the coils described above.

In the present embodiment, the connection segment connected to one ends of two adjacent coils and the intermediate segment between the two connection segments connected to either coil different from the two coils have the same potential.

In FIG. 9, it is described below as example of the connection segment C4 connected to one ends of the first coil 31 and the second coil 32 adjacent to the first coil 31. The connection segment C4, an intermediate segment C11 and an intermediate segment C18 are connected to one another. The intermediate segment C11 is arranged between the two connection segments C10 and C13 connected to the fourth coil 34. The fourth coil 34 is different from the two coils 31 and 32. And an intermediate segment C18 is arranged between the two connection segments C16 and C19 connected to the sixth coil 36. Therefore, the three segments, the connection segment C4, the intermediate segment C11, and the intermediate segment C18 have the same potential.

Other relationships between the segments in the segments C1 to C21 are similar to the relationship between the segments described above.

In the present embodiment, a position of the connection segment and a position of the other intermediate segment having the same potential as the potential of the connection segment in the circumferential direction of the commutator 4 (arrow X direction) have a rotationally symmetrical positional relationship.

In FIG. 9, when the connection segment C4 is described as an example, the position of the connection segment C4, the position of the intermediate segment C11 having the same potential as the segment C13, and the position of the intermediate segment C18 having the same potential as the segment C13 in the circumferential direction of the commutator (arrow X direction) 4 have a rotationally symmetrical (specifically, three-fold symmetrical) positional relationship.

Other relationships between the segments having the same potential in the segments C1 to C21 are similar to the relationship between the segments described above.

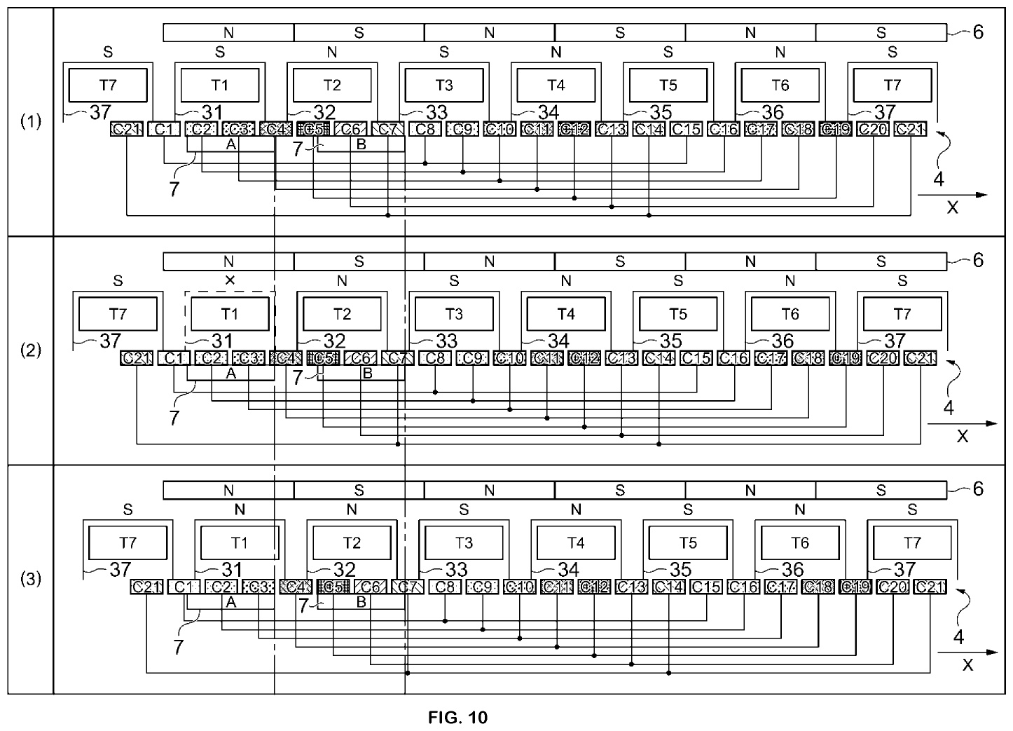

Regarding the operation of the motor according to the present embodiment, the illustrative diagrams similar to FIGS. 4 and 5 in the first embodiment are also presented in the present embodiment as FIGS. 10 to 12, and the detailed description thereof will be omitted.

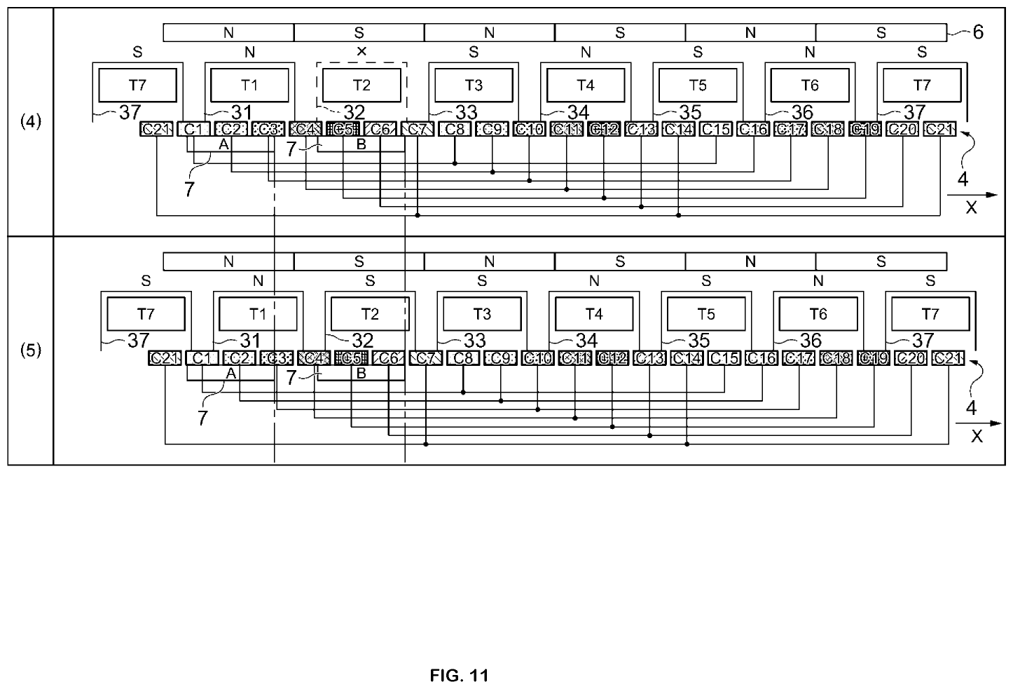

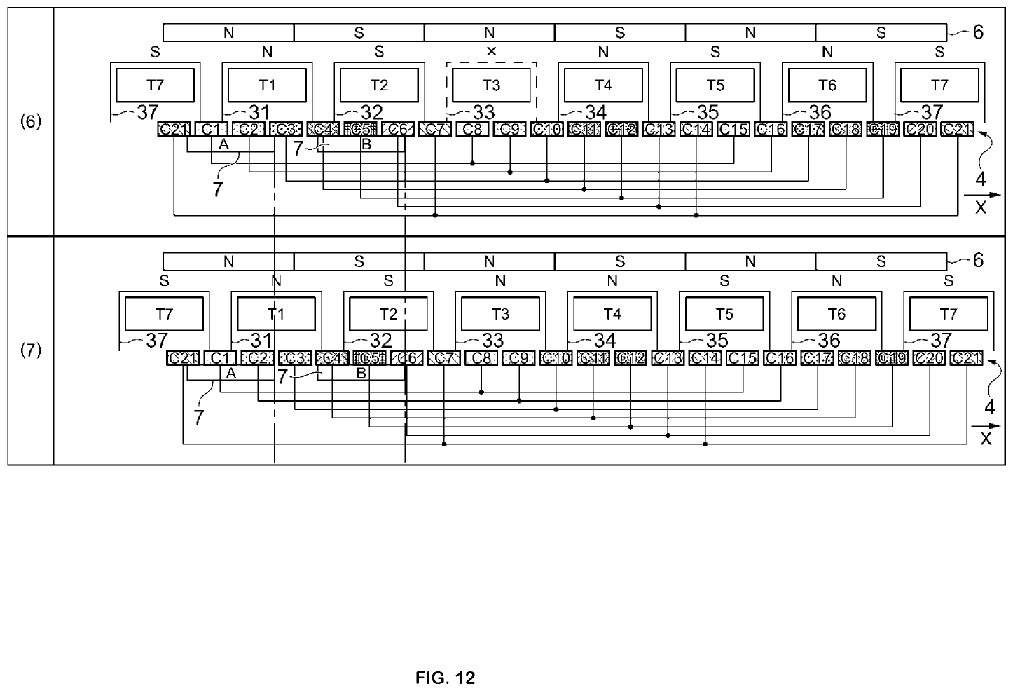

FIGS. 10 to 12 are illustrative diagrams for illustrating a change in a magnetic pole of the slots and a movement of components of the armature 10 in time series when a predetermined current or voltage is applied to the motor according to the present embodiment. Similarly to the schematic diagram in FIG. 9, each diagram of (1) to (3) in FIG. 10, (4) and (5) in FIG. 11, and (6) and (7) in FIG. 12 is obtained by developing each component of the armature 10 arranged in the circumferential direction in a left-right direction, and showing a mutual relationship (positional relationship, connection relationship).

FIGS. 10 to 12 illustrate a state of the teeth T1 to T7 as the components of the armature 10 sequentially moving in the arrow X direction from (1) in FIG. 10 to (7) in FIG. 12 with the lapse of time, and a contact state (energization state) between the contact portions A and B of the plurality of brushes 7 and the segments C1 to C21 is switched.

Also in the motor according to the present embodiment, as in the case of the first embodiment, in accordance with the change in the contact state between the plurality of brushes 7 and the commutator 4, the current having determined positive and negative directions flows through the first to seventh coils 31 to 37 via each connection wiring. As a result, as illustrated in (1) to (3) in FIG. 10, (4) and (5) in FIG. 11, and (6) and (7) in FIG. 12, the teeth T1 to T7 indicate respective magnetic poles. Due to the interaction between the magnetic poles of the teeth T1 to T7 and the magnetic poles of the magnet 6 due to the attractive force or the repulsive force, the commutator 4 and the like move in the arrow X direction, and the rotation of the shaft 8 is maintained.

In the motor according to the present embodiment, by applying the predetermined current or voltage to the plurality of brushes 7, the rotation of the commutator 4 and the like in the arrow X direction is maintained as illustrated in the time series of (1) to (7) in FIGS. 10 to 12. The rotation of the motor is continued by further continuing the rotation.

According to the motor in the present embodiment, the contact portions A and B of the plurality of brushes 7 are in contact with two or more adjacent segments at the same time. Therefore, since the width x of the contact portions A and B is wide, it is possible to smoothly extend over the slit (gap between adjacent segments) of the commutator 4. Therefore, according to the motor in the present embodiment, since the plurality of brushes 7 are less likely to be shaken, it is possible to reduce noise caused by the shaking of the plurality of brushes 7.

According to the motor in the present embodiment, in a connection method at the time of assembling the armature 10, since the width x of the contact portions A and B of the plurality of brushes 7 is wide, it is possible to improve the energization efficiency and the reliability (in particular, to improve the life of the motor).

Although the commutator has 21 segments, the width x of the contact portions A and B of the plurality of brushes 7 can be widened, so that the number of slots can be reduced to seven, and the space for the winding can be easily ensured. Since it is easy to ensure a space for the winding, a space factor can be improved. As a result, the size of the motor can be reduced and the torque can be increased.

In the motor in the present embodiment, since the coils 3 are concentrated winding and a winding portion can be made thinner than overlapping winding, the number of stacked magnetic bodies (electrical steel plates) constituting the rotor core 2 having the slots can be increased, and magnetic efficiency can be increased.

In the motor in the present embodiment, when an improvement state of the cogging torque with respect to the 6-pole 21-slot motor including the coils wound in the overlapping manner is confirmed, it is possible to confirm the improvement of 10% or more of the load fluctuation rate. Therefore, according to the motor in the present embodiment, it can be seen that the cogging torque can be reduced.

### Fourth Embodiment

A motor according to a fourth embodiment as an example of the first invention will be described. The motor according to the fourth embodiment is different from the motor 1 according to the first embodiment in the connection of the coils 3 and the configuration of the connection wiring between the segments. That is, in the present embodiment, the number of slots (five slots) of the rotor core 2 and the number of segments (ten segments) of the commutator 4 are the same as those in the first embodiment. The positional relationship between the slots (teeth T1 to T10) of the rotor core 2 and the segments C1 to C10 of the commutator 4 is shifted by 180°.

Therefore, since the overall configuration and the like of the motor according to the present embodiment are the overall configuration and the like of the first embodiment, please refer to FIG. 1 representing the motor 1 according to the first embodiment. The same reference numerals as those in the first embodiment are used for the reference numerals.

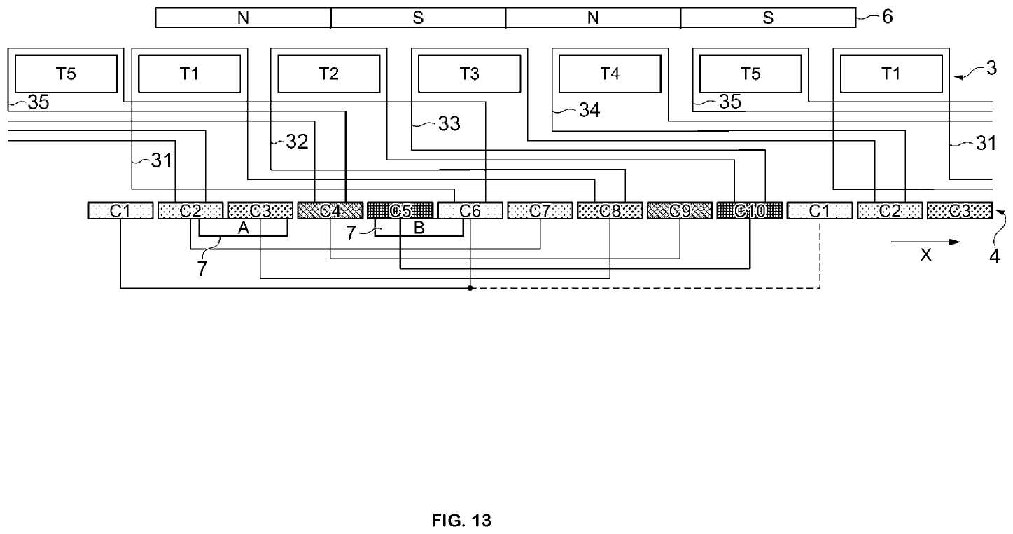

FIG. 13 is a schematic diagram formed by developing each component of the armature arranged in the circumferential direction in the left-right direction, and showing a mutual relationship (positional relationship, connection relationship) in the motor according to the fourth embodiment as an example of the first invention.

As shown in FIG. 13, the rotor core 2 includes the first tooth T1 to the fifth tooth T5 as a plurality of (five in the present embodiment) slots arranged in the circumferential direction. The coils 31 to 35 are wound around the first tooth T1 to the fifth tooth T5, respectively. The coils 31 to 35 have the same number of turns and the same winding axis direction (spiral direction).

The commutator 4 has the segments C1 to C10 as the plurality of segments arranged in the circumferential direction. The segments C1 to C10 are brought into contact with the contact portions A and B of the plurality of brushes 7 and energized.

A size relationship between the contact portions A and B of the plurality of brushes 7 and the segments (C1 to C10) in the commutator 4 satisfies the above-described relational expression (1).

In the present embodiment, both ends of each coil 3 are connected to two segments (connection segments) among the plurality of segments C1 to C10, and another segment (intermediate segment) is arranged between the two segments. Both ends of the coil 3 are not connected to the another segment (intermediate segment).

In FIG. 13, the first coil 31 is described as an example. First, both ends of the first coil 31 are connected to two connection segments C6 and C8. Then, another intermediate segment C7 is arranged between the two connection segments C6 and C8. Both ends of the coil 3 are not connected to the another intermediate segment C7.

A relationship between the segments and the coil described above is the same for the remaining second coil 32 to the seventh coil 37.

In the present embodiment, one ends of two adjacent coils are connected to one segment of the two segments (the connection segments connected to both ends of the coil 3).

In FIG. 13, when the first coil 31 and the second coil 32 adjacent to the first coil 31 are described as an example, one ends of the first coil 31 and the second coil 32 are connected to one segment (C8) of the connection segments C6 and C8 connected to both ends of the first coil 31.

Other adjacent relationships of the first coil 31 to the fifth coil 35 are similar to the relationship between the segments and the coils described above.

In the present embodiment, the connection segment connected to one ends of two adjacent coils and the intermediate segment between the two connection segments connected to either coil different from the two coils have the same potential.

In FIG. 13, when the connection segment C8 connected to one ends of the first coil 31 and the second coil 32 adjacent to the first coil 31 is described as an example, the connection segment C8 and the intermediate segment C3 between two connection segments C2 and C4 connected to the fifth coil 35 different from the two coils 31 and 32 are connected. Therefore, the connection segment C8 and the intermediate segment C6 have the same potential.

Other relationships between the segments in the segments C1 to C10 are similar to the relationship between the segments described above.

In the present embodiment, a position of the connection segment and a position of the other intermediate segment having the same potential as the potential of the connection segment in the circumferential direction of the commutator 4 (arrow X direction) have a rotationally symmetrical positional relationship.

In FIG. 13, when the connection segment C8 is described as an example, the position of the connection segment C8 and the position of the intermediate segment C3 having the same potential as the potential of the connection segment C8 in the circumferential direction of the commutator 4 (arrow X direction) have a rotationally symmetrical (specifically, two-fold symmetrical) positional relationship.

Other relationships between the segments having the same potential in the segments C1 to C10 are similar to the relationship between the segments described above.

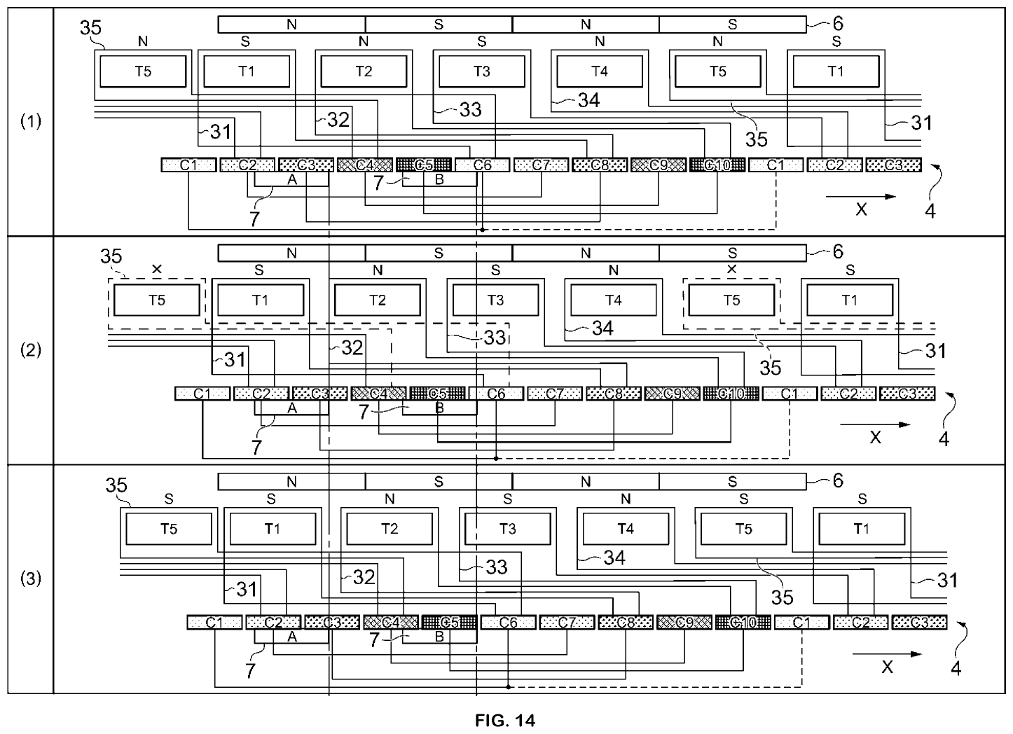

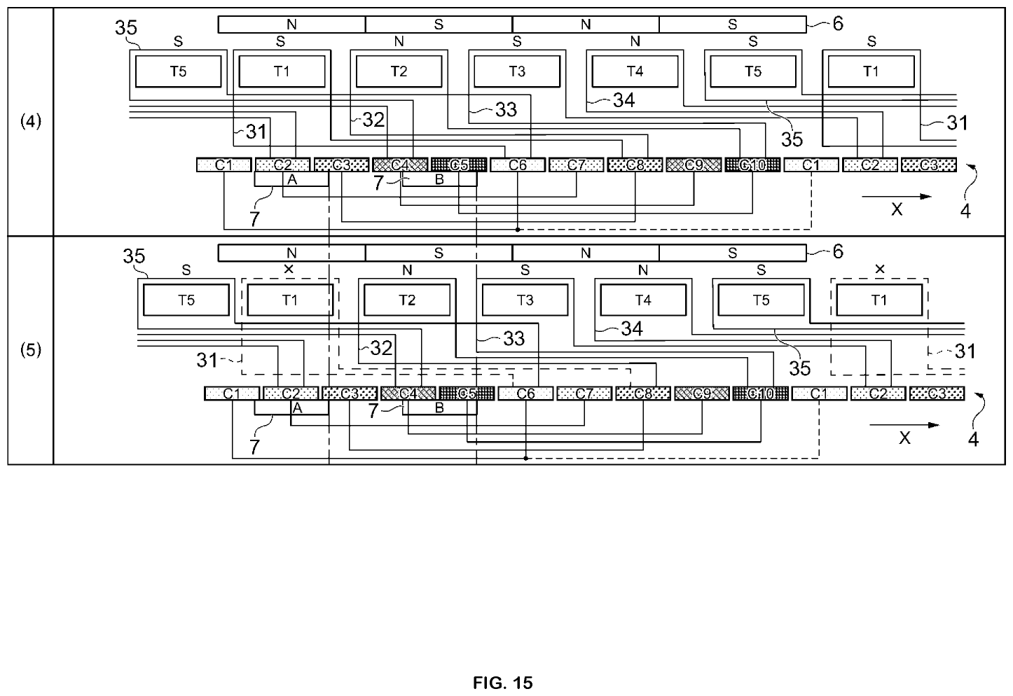

Regarding the operation of the motor according to the present embodiment, the illustrative diagrams similar to FIGS. 4 and 5 in the first embodiment are also presented in the present embodiment as FIGS. 14 and 15, and the detailed description thereof will be omitted.

FIGS. 14 and 15 are illustrative diagrams for illustrating a change in a magnetic pole of the slots and a movement of components of the armature 10 in time series when a predetermined current or voltage is applied to the motor according to the present embodiment. Similarly to the schematic diagram in FIG. 6, each diagram of (1) to (3) in FIG. 7 and (4) and (5) in FIG. 8 is obtained by developing each component of the armature 10 arranged in the circumferential direction in a left-right direction, and showing a mutual relationship (positional relationship, connection relationship). In the present embodiment, presentation of a drawing corresponding to FIG. 8(4) in the first embodiment is omitted.

FIGS. 14 and 15 illustrate a state of the teeth T1 to T5 as the components of the armature 10 sequentially moving in the arrow X direction from (1) in FIG. 14 to (5) in FIG. 15 with the lapse of time, and a contact state (energization state) between the contact portions A and B of the plurality of brushes 7 and the segments C1 to C10 is switched.

Also in the motor according to the present embodiment, as in the case of the first embodiment, in accordance with the change in the contact state between the plurality of brushes 7 and the commutator 4, the current having determined positive and negative directions flows through the first to fifth coils 31 to 35 via each connection wiring. As a result, as illustrated in (1) to (3) in FIG. 14 and (4) and (5) in FIG. 15, the teeth T1 to T5 indicate respective magnetic poles. Due to the interaction between the magnetic poles of the teeth T1 to T5 and the magnetic poles of the magnet 6 due to the attractive force or the repulsive force, the commutator 4 and the like move in the arrow X direction, and the rotation of the shaft 8 is maintained.

In the motor according to the present embodiment, by applying the predetermined current or voltage to the plurality of brushes 7, the rotation of the commutator 4 and the like in the arrow X direction is maintained as illustrated in the time series of (1) to (5) in the above FIGS. 14 and 15. The rotation of the motor is continued by further continuing applying the predetermined current or voltage to the plurality of brushes.

According to the motor in the present embodiment, the contact portions A and B of the plurality of brushes 7 are in contact with two or more adjacent segments at the same time. Therefore, since the width x of the contact portions A and B is wide, it is possible to smoothly extend over the slit (gap between adjacent segments) of the commutator 4. Therefore, according to the motor in the present embodiment, since the plurality of brushes 7 are less likely to be shaken, it is possible to reduce noise caused by the shaking of the plurality of brushes 7.

According to the motor in the present embodiment, in a connection method at the time of assembling the armature 10, since the width x of the contact portions A and B of the plurality of brushes 7 is wide, it is possible to improve the energization efficiency and the reliability (in particular, to increase the life of the motor).

Although the commutator has ten segments, the width x of the contact portions A and B of the plurality of brushes 7 can be widened, so that the number of slots can be reduced to five, and the space for the winding can be easily ensured. Since it is easy to ensure a space for the winding, a space factor of the coil can be improved. As a result, the size of the motor can be reduced and torque can be increased.

In the motor in the present embodiment, since the coils 3 are concentrated winding and a winding portion can be made thinner than overlapping winding, the number of stacked magnetic bodies (electrical steel plates) constituting the rotor core 2 having the slots can be increased, and magnetic efficiency can be improved.

In the motor in the present embodiment, when an improvement state of the cogging torque with respect to the 4-pole 10-slot motor including the coils wound in the overlapping manner is confirmed, it is possible to confirm the improvement of 10% or more of the load fluctuation rate. Therefore, according to the motor in the present embodiment, it can be seen that the cogging torque can be reduced.

### [Second Invention]

A motor according to a second invention includes:

a magnet including a plurality of magnetic poles;

a plurality of slots opposing the magnet;

a coil wound around each of the plurality of slots;

a commutator including a plurality of segments; and

a plurality of brushes, each of the plurality of brushes including a contact portion contacting two adjacent segments among the plurality of segments, wherein

both ends of the coil are connected to two segments among the plurality of segments, and another two segments are arranged between the two segments,

one ends of two coils adjacent to both sides of the coil are respectively connected to the another two segments, and

in a circumferential direction of the commutator, the segments in a rotationally symmetrical positional relationship have the same potential.

Hereinafter, fifth to seventh embodiments as exemplary aspects of the second invention will be described with reference to the drawings.

### Fifth Embodiment

A motor according to the fifth embodiment as an example of the second invention will be described. The motor according to the fifth embodiment is different from the motor 1 according to the first embodiment in the connection of the coils 3 and the configuration of the connection wiring between the segments. That is, in the present embodiment, the number of slots (five slots) of the rotor core 2 and the number of segments (ten segments) of the commutator 4 are the same as those in the first embodiment.

Therefore, since the overall configuration and the like of the motor according to the present embodiment are the same as the overall configuration and the like of the first embodiment, please refer to FIG. 1 representing the motor 1 according to the first embodiment. The same reference numerals as those in the first embodiment are used for the reference numerals.

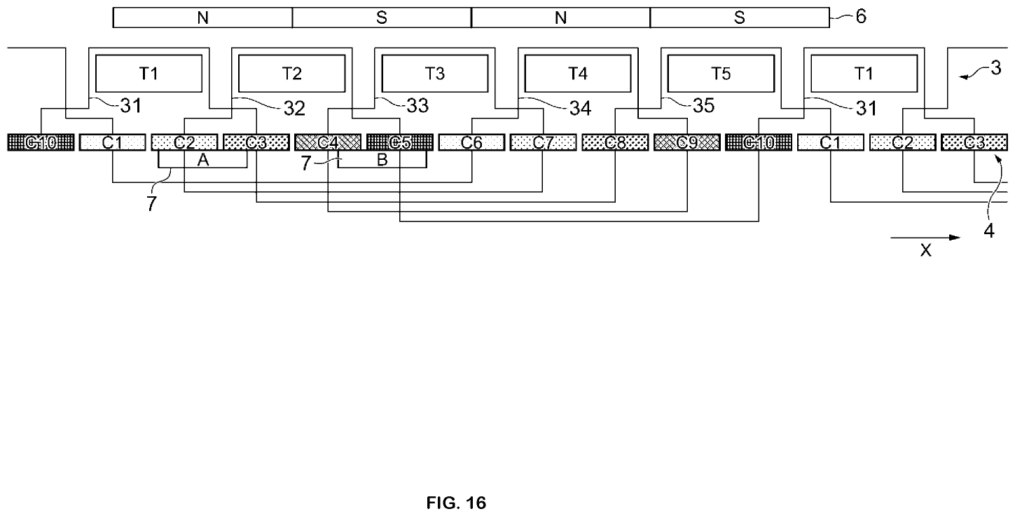

FIG. 16 is a schematic diagram formed by developing each component of an armature arranged in the circumferential direction in the left-right direction, and showing a mutual relationship (positional relationship, connection relationship) in the motor according to the fifth embodiment as an example of the second invention.

As shown in FIG. 16, the rotor core 2 includes the first tooth T1 to the fifth tooth T5 as a plurality of (five in the present embodiment) slots arranged in the circumferential direction. The coils 31 to 35 are wound around the first tooth T1 to the fifth tooth T5, respectively. The coils 31 to 35 have the same number of turns and the same winding axis direction (spiral direction).

The commutator 4 has segments C1 to C10 as the plurality of segments arranged in the circumferential direction. The segments C1 to C10 are brought into contact with contact portions A and B of the plurality of brushes 7 and energized.

A size relationship between the contact portions A and B of the plurality of brushes 7 and the segments (C1 to C10) in the commutator 4 satisfies the above-described relational expression (1).

In the present embodiment, both ends of each coil 3 are connected to two segments among the plurality of segments C1 to C10, and another two segments are arranged between the two segments. Both ends of the coil 3 are not connected to the another two segments.

In FIG. 16, when the first coil 31 is described as an example, first, both ends of the first coil 31 are connected to two segments C10 and C3. Then, another segments C1 and C2 are arranged between the two segments C10 and C3. Both ends of the first coil 31 are not connected to the another segments C1 and C2.

A relationship between the segments and the coil described above is the same for the remaining second coil 32 to the fifth coil 35.

In the present embodiment, one end of each of two coils adjacent to both sides of the coil is connected to each of the another two segments not connected to both ends of the coil.

In FIG. 16, when the first coil 31 is described as an example, one end of each of two coils of the fifth coil 35 and the second coil 32 adjacent to both sides of the first coil 31 is connected to each of the another two segments C1 and C2 not connected to both ends of the first coil 31.

Other adjacent relationships of the first coil 31 to the fifth coil 35 are similar to the relationship between the segments and the coils described above.

In the present embodiment, the segments having the rotationally symmetrical positional relationship in the circumferential direction of the commutator 4 (arrow X direction) have the same potential.

In FIG. 16, when the connection segment C3 is described as an example, the connection segment C3 and the segment C8 having the rotationally symmetrical (specifically, two-fold symmetrical) positional relationship in the circumferential direction of the commutator 4 (arrow X direction) have the same potential.

Other relationships among the segments C1 to C10 having the rotationally symmetrical positional relationship in the circumferential direction of the commutator 4 (arrow X direction) are similar to the above relationship among the segments.

An operation of the motor according to the present embodiment will be described.

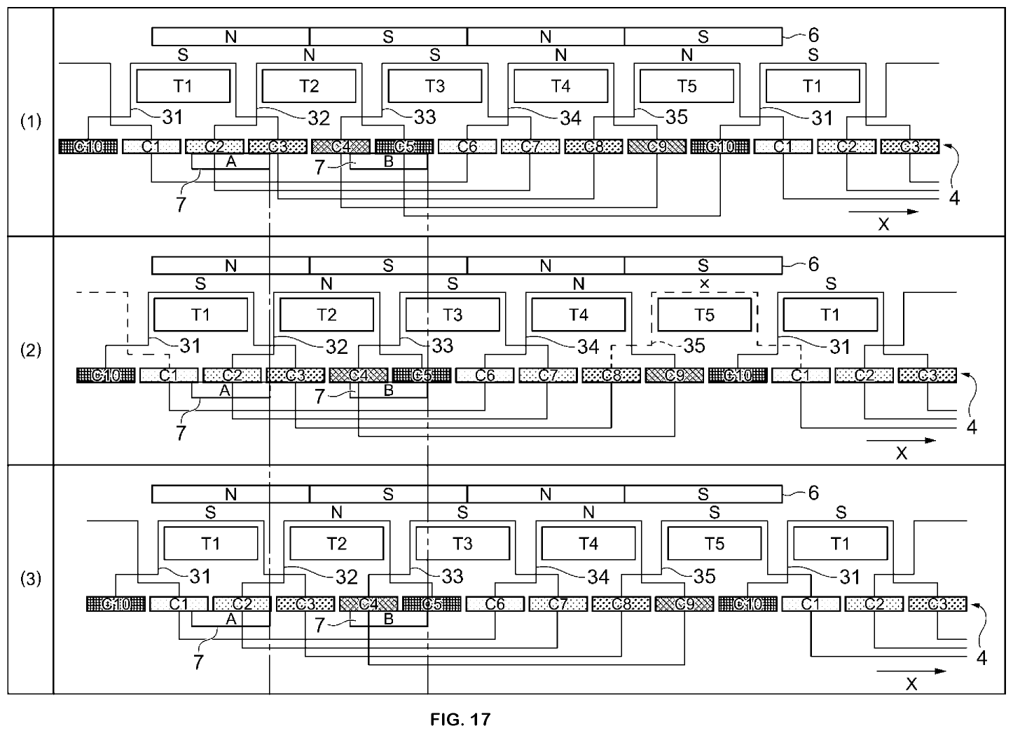

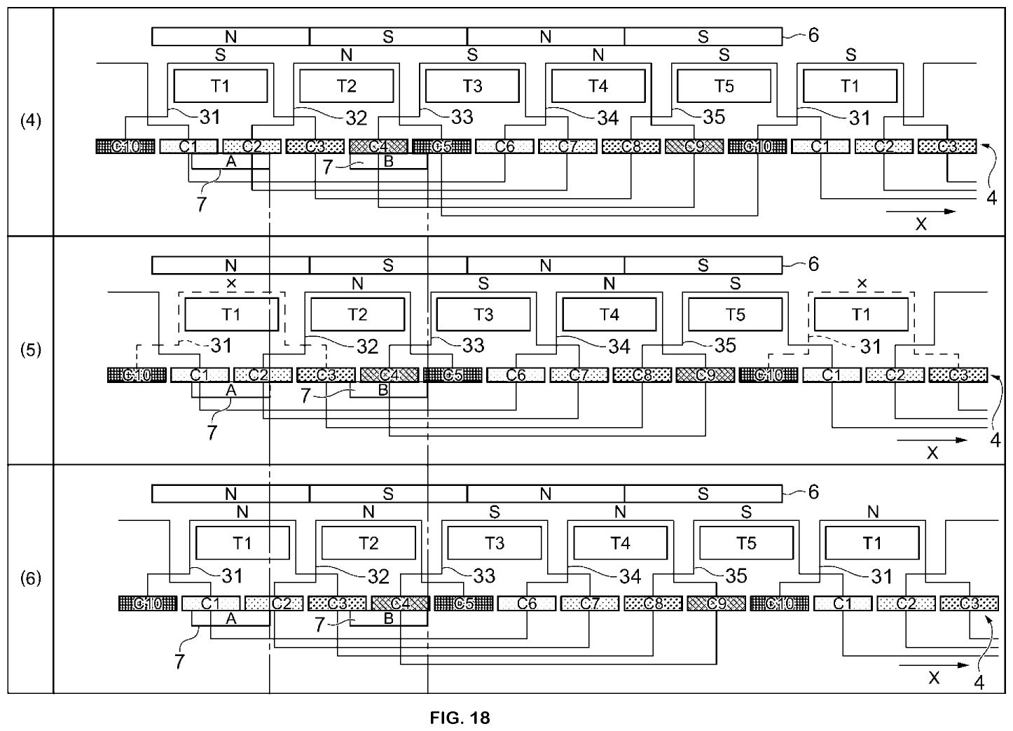

FIGS. 17 and 18 are illustrative diagrams for illustrating a change in a magnetic pole of the slots and a movement of components of the armature 10 in time series when a predetermined current or voltage is applied to the motor according to the present embodiment. Similarly to the schematic diagram in FIG. 16, each diagram of (1) to (3) in FIG. 17, and (4) to (6) in FIG. 18 is obtained by developing each component of the armature 10 arranged in the circumferential direction in a left-right direction, and showing a mutual relationship (positional relationship, connection relationship).

FIGS. 17 and 18 illustrate a state of the teeth T1 to T5 as the components of the armature 10 sequentially moving in the arrow X direction from (1) in FIG. 17 to (6) in FIG. 18 with the lapse of time, and a contact state (energization state) between the contact portions A and B of the plurality of brushes 7 and the segments C1 to C10 is switched. In order to make it easy to understand the positional relationship between the contact portions A and B of the plurality of brushes 7 and the teeth T1 to T5 and the like, in FIGS. 17 and 18, a one-dot chain line is attached to a right end of the contact portion A and a two-dot chain line is attached to a right end of the contact portion B as auxiliary lines over each time series.

First, in the state of FIG. 17(1), a predetermined DC voltage is applied to the contact portions A and B of the plurality of brushes 7 (in the present embodiment, the contact portion A is positive and the contact portion B is negative). In the state of FIG. 17(1), the contact portion A of one brush 7 is in contact with the segments C2 and C3 of the commutator 4, and the contact portion B of the other brush 7 is in contact with the segments C4 and C5.

The applied voltage is applied to each of the first to fifth coils 31 to 35 via each connection wiring according to the contact state between the plurality of brushes 7 and the commutator 4, and a current having determined positive and negative directions flows. Then, as shown in FIG. 17(1), the magnetic poles of the teeth T1 to T5 become SNSNN.

Due to an interaction caused by an attractive force or a repulsive force between the magnetic poles of the teeth T1 to T5 and the magnetic poles of the magnet 6, the teeth (slots) T1 to T5 as the components of the armature 10, the first to fifth coils 31 to 35, and the segments C1 to C10 (hereinafter, may be referred to as “commutator 4 or the like”) move in the arrow X direction, and the shaft 8 rotates.

When the commutator 4 and the like move to the state of FIG. 17(2), the contact portion A of one brush 7 comes into contact with the segments C1, C2, and C3, and the contact portion B of the other brush 7 remains in contact with the segments C4 and C5. Due to the change in the contact state between the plurality of brushes 7 and the commutator 4, the positive and negative directions of the currents flowing through the first to fifth coils 31 to 35 also change. As shown in FIG. 17(2), the magnetic poles of the teeth T1 to T5 are SNSNx.

Due to the interaction between the magnetic poles of the teeth T1 to T5 and the magnetic poles of the magnet 6 due to the attractive force or the repulsive force, the commutator 4 and the like move in the arrow X direction, and the rotation of the shaft 8 is maintained.

When the commutator 4 and the like move to the state of FIG. 17(3), the contact portion A of one brush 7 is in contact with the segments C1 and C2, and the contact portion B of the other brush 7 remains in contact with the segments C4 and C5. Due to the change in the contact state between the plurality of brushes 7 and the commutator 4, the positive and negative directions of the currents flowing through the first to fifth coils 31 to 35 also change. As shown in FIG. 17(3), the magnetic poles of the teeth T1 to T5 are SNSNS.

Due to the interaction between the magnetic poles of the teeth T1 to T5 and the magnetic poles of the magnet 6 due to the attractive force or the repulsive force, the commutator 4 and the like move in the arrow X direction, and the rotation of the shaft 8 is maintained.

Next, although the commutator 4 and the like move to the state shown in FIG. 18(4), the contact state between the commutator 4 and the contact portions A and B of the plurality of brushes 7 is not different from the state shown in FIG. 17(3). Therefore, also in the state of FIG. 18(4), similarly to the state of FIG. 17(3), due to the interaction between the magnetic poles of the teeth T1 to T5 and the magnetic poles of the magnet 6 due to the attractive force or the repulsive force, the commutator 4 and the like move in the arrow X direction, and the rotation of the shaft 8 is maintained.

When the commutator 4 and the like move to the state of FIG. 18(5), the contact portion A of one brush 7 remains in contact with the segments C1 and C2, and the contact portion B of the other brush 7 is in contact with the segments C3, C4, and C5. Due to the change in the contact state between the plurality of brushes 7 and the commutator 4, the positive and negative directions of the currents flowing through the first to fifth coils 31 to 35 also change. As shown in FIG. 18(5), the magnetic poles of the teeth T1 to T5 are ×NSNS.

Due to the interaction between the magnetic poles of the teeth T1 to T5 and the magnetic poles of the magnet 6 due to the attractive force or the repulsive force, the commutator 4 and the like move in the arrow X direction, and the rotation of the shaft 8 is maintained.

When the commutator 4 and the like move to the state of FIG. 18(6), the contact portion A of one brush 7 remains in contact with the segments C1 and C2, and the contact portion B of the other brush 7 is in contact with the segments C3 and C4. Due to the change in the contact state between the plurality of brushes 7 and the commutator 4, the positive and negative directions of the currents flowing through the first to fifth coils 31 to 35 also change. As shown in FIG. 5(6), the magnetic poles of the teeth T1 to T5 are NNSNS.

Due to the interaction between the magnetic poles of the teeth T1 to T5 and the magnetic poles of the magnet 6 due to the attractive force or the repulsive force, the commutator 4 and the like move in the arrow X direction, and the rotation of the shaft 8 is maintained.

In the motor 1 according to the present embodiment, by applying the predetermined current or voltage to the plurality of brushes 7, the rotation of the commutator 4 and the like in the arrow X direction is maintained as illustrated in the time series of (1) to (6) in the above FIGS. 17 and 18. The rotation of the motor is continued by further continuing applying the predetermined current or voltage to the plurality of brushes.

According to the motor in the present embodiment, the contact portions A and B of the plurality of brushes 7 are in contact with two or more adjacent segments at the same time. Therefore, since the width x of the contact portions A and B is wide, it is possible to smoothly extend over the slit (gap between adjacent segments) of the commutator 4. Therefore, according to the motor in the present embodiment, since the plurality of brushes 7 are less likely to be shaken, it is possible to reduce noise caused by the shaking of the plurality of brushes 7.

According to the motor in the present embodiment, in a connection method at the time of assembling the armature 10, since the width x of the contact portions A and B of the plurality of brushes 7 is wide, it is possible to improve the energization efficiency and the reliability (in particular, to improve the life of the motor).

Although the commutator has ten segments, the width x of the contact portions A and B of the plurality of brushes 7 can be widened, so that the number of slots can be reduced to five, and the space for the winding can be easily ensured. Since it is easy to ensure a space for the winding, a space factor can be improved. As a result, the size of the motor can be reduced and torque can be increased.

In the motor in the present embodiment, since the coils 3 are concentrated winding and a winding portion can be made thinner than overlapping winding, the number of stacked magnetic bodies (electrical steel plates) constituting the rotor core 2 having the slots can be increased, and magnetic efficiency can be increased.

In the motor in the present embodiment, when an improvement state of the cogging torque with respect to the 4-pole 10-slot motor including the coils wound in the overlapping manner is confirmed, it is possible to confirm the improvement of 10% or more of the load fluctuation rate. Therefore, according to the motor in the present embodiment, it can be seen that the cogging torque can be reduced.

### Sixth Embodiment

A motor according to the sixth embodiment as an example of the second invention will be described. The motor according to the sixth embodiment is different from the motor 1 according to the first embodiment in the connection of the coils 3 and the configuration of the connection wiring between the segments. That is, in the present embodiment, the number of slots (five slots) of the rotor core 2 and the number of segments (ten segments) of the commutator 4 are the same as those in the first embodiment.

Therefore, since the overall configuration and the like of the motor according to the present embodiment are the same as the overall configuration and the like of the first embodiment, please refer to FIG. 1 representing the motor 1 according to the first embodiment. The same reference numerals as those in the first embodiment are used for the reference numerals.

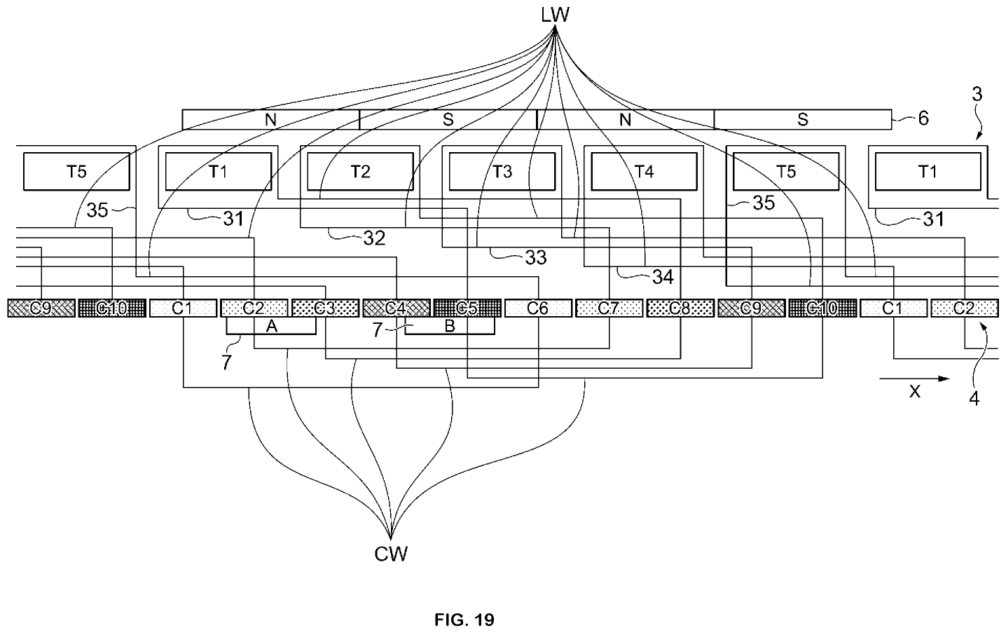

FIG. 19 is a schematic diagram formed by developing each component of an armature arranged in the circumferential direction in the left-right direction, and showing a mutual relationship (positional relationship, connection relationship) in the motor according to the sixth embodiment as an example of the second invention.

As shown in FIG. 19, the rotor core 2 includes the first tooth T1 to the fifth tooth T5 as a plurality of (five in the present embodiment) slots arranged in the circumferential direction. The coils 31 to 35 are wound around the first tooth T1 to the fifth tooth T5, respectively. The coils 31 to 35 have the same number of turns and the same winding axis direction (spiral direction).

The commutator 4 has segments C1 to C10 as the plurality of segments arranged in the circumferential direction. The segments C1 to C10 are brought into contact with the contact portions A and B of the plurality of brushes 7 and energized.

A size relationship between the contact portions A and B of the plurality of brushes 7 and the segments (C1 to C10) in the commutator 4 satisfies the above-described relational expression (1).

In the present embodiment, both ends of each coil 3 are connected to two segments among the plurality of segments C1 to C10, and another two segments are arranged between the two segments. Both ends of the coil 3 are not connected to the another two segments.

In FIG. 19, when the first coil 31 is described as an example, first, both ends of the first coil 31 are connected to two segments C5 and C8. Then, another segments C6 and C7 are arranged between the two segments C5 and C8. Both ends of the first coil 31 are not connected to the another segments C6 and C7.

A relationship between the segments and the coil described above is the same for the remaining second coil 32 to the fifth coil 35.

In the present embodiment, one end of each of two coils adjacent to both sides of the coil is connected to each of the another two segments connected to both ends of the coil.

In FIG. 19, when the first coil 31 is described as an example, one end of each of two coils of the fifth coil 35 and the second coil 32 adjacent to both sides of the first coil 31 is connected to each of the another two segments C6 and C7. Both ends of the first coil 31 are not connected to the another two segments C6 and C7.

Other adjacent relationships of the first coil 31 to the fifth coil 35 are similar to the relationship between the segments and the coils described above.

In the present embodiment, the segments having the rotationally symmetrical positional relationship in the circumferential direction of the commutator 4 (arrow X direction) have the same potential.

In FIG. 19, when the connection segment C3 is described as an example, the connection segment C3 and the segment C8 having the rotationally symmetrical (specifically, two-fold symmetrical) positional relationship in the circumferential direction of the commutator 4 (arrow X direction) have the same potential.

Other relationships among the segments C1 to C10 having the rotationally symmetrical positional relationship in the circumferential direction of the commutator 4 (arrow X direction) are similar to the above relationship among the segments.

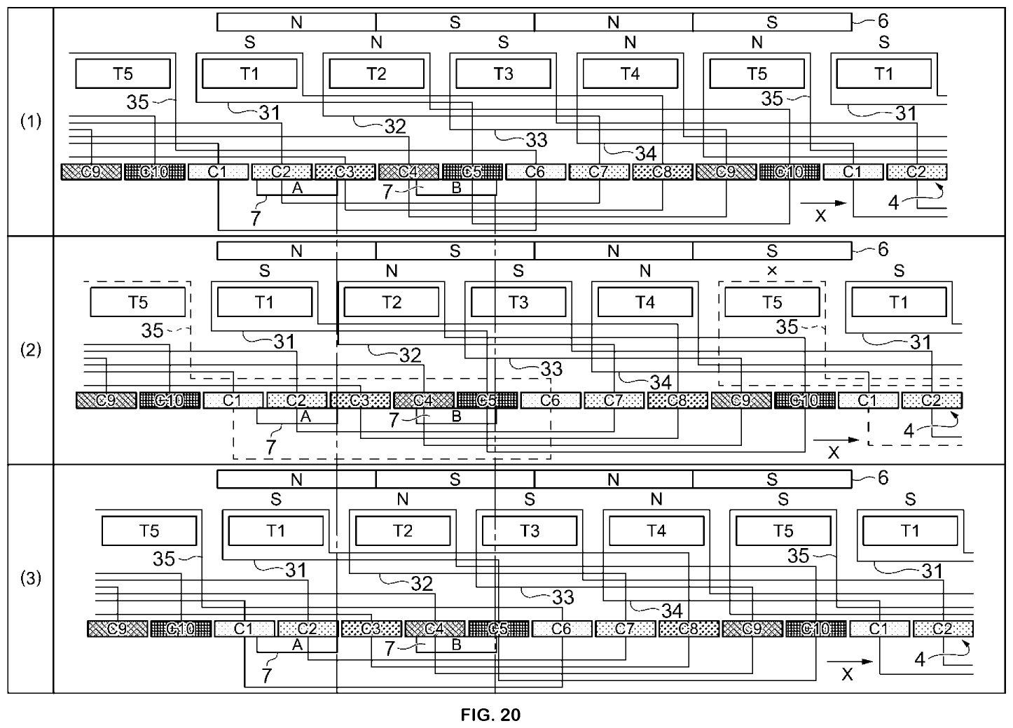

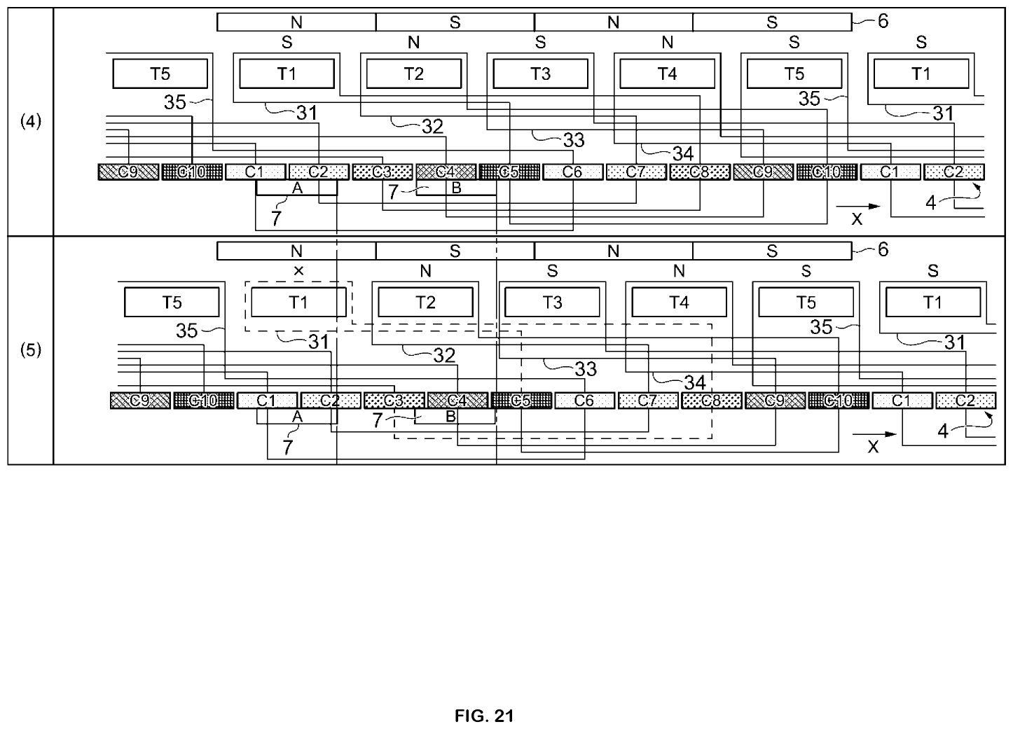

Regarding the operation of the motor according to the present embodiment, the illustrative diagrams similar to FIGS. 17 and 18 in the fifth embodiment are also presented in the present embodiment as FIGS. 20 and 21, and the detailed description thereof will be omitted.

FIGS. 20 and 21 are illustrative diagrams for illustrating a change in a magnetic pole of the slots and a movement of components of the armature 10 in time series when a predetermined current or voltage is applied to the motor according to the present embodiment. Similarly to the schematic diagram in FIG. 19, each diagram of (1) to (3) in FIG. 20, (4) and (5) in FIG. 21 is obtained by developing each component of the armature 10 arranged in the circumferential direction in a left-right direction, and showing a mutual relationship (positional relationship, connection relationship). In the present embodiment, presentation of a drawing corresponding to FIG. 8(4) in the fifth embodiment is omitted.

FIGS. 19, 20, and 21 illustrate a state of crossover wirings CW (see FIG. 19) connected such that the plurality of segments have the same potential. Lead wirings LW (see FIG. 19) drawn out from the coils 3 are curved and routed to connect to the segments. In a radial direction, a gap between two adjacent slits among the plurality of slits and a gap between two adjacent segments oppose each other. The plurality of coils, the plurality of lead wirings, and the plurality of crossover wirings CW may be formed with one conducting wiring.

FIGS. 20 and 21 illustrate a state of the teeth T1 to T5 as the components of the armature 10 sequentially moving in the arrow X direction from (1) in FIG. 20 to (5) in FIG. 21 with the lapse of time, and a contact state (energization state) between the contact portions A and B of the plurality of brushes 7 and the segments C1 to C10 is switched.

Also in the motor according to the present embodiment, as in the case of the fifth embodiment, in accordance with the change in the contact state between the plurality of brushes 7 and the commutator 4, the current whose positive and negative directions are selected flows through the first to fifth coils 31 to 35 via each connection wiring. As a result, as illustrated in (1) to (3) in FIG. 20 and (4) and (5) in FIG. 21, the teeth T1 to T5 indicate respective magnetic poles. Due to the interaction between the magnetic poles of the teeth T1 to T5 and the magnetic poles of the magnet 6 due to the attractive force or the repulsive force, the commutator 4 and the like move in the arrow X direction, and the rotation of the shaft 8 is maintained.

In the motor according to the present embodiment, by applying the predetermined current or voltage to the plurality of brushes 7, the rotation of the commutator 4 and the like in the arrow X direction is maintained as illustrated in the time series of (1) to (5) in the above FIGS. 20 and 21. The rotation of the motor is continued by further continuing applying the predetermined current or voltage to the plurality of brushes.

According to the motor in the present embodiment, the contact portions A and B of the plurality of brushes 7 are in contact with two or more adjacent segments at the same time. Therefore, since the width x of the contact portions A and B is wide, it is possible to smoothly extend over the slit (gap between adjacent segments) of the commutator 4. Therefore, according to the motor in the present embodiment, since the plurality of brushes 7 are less likely to be shaken, it is possible to reduce noise caused by the shaking of the plurality of brushes 7.

According to the motor in the present embodiment, in a connection method at the time of assembling the armature 10, since the width x of the contact portions A and B of the plurality of brushes 7 is wide, it is possible to improve the energization efficiency and the reliability (in particular, to increase the life of the motor).

Although the commutator has ten segments, the width x of the contact portions A and B of the plurality of brushes 7 can be widened, so that the number of slots can be reduced to five, and the space for the winding can be easily ensured. Since it is easy to ensure a space for the winding, a space factor can be improved. As a result, the size of the motor can be reduced and torque can be increased.

In the motor in the present embodiment, since the coils 3 are concentrated winding and a winding portion can be made thinner than overlapping winding, the number of stacked magnetic bodies (electrical steel plates) constituting the rotor core 2 having the slots can be increased, and magnetic efficiency can be increased.

In the motor in the present embodiment, when an improvement state of the cogging torque with respect to the 4-pole 10-slot motor including the coils wound in the overlapping manner is confirmed, it is possible to confirm the improvement of 10% or more of the load fluctuation rate. Therefore, according to the motor in the present embodiment, it can be seen that the cogging torque can be reduced.

In addition, by constituting the wiring structures of the lead wiring and the crossover wiring and the arrangements of the segment and the slit as in the present embodiment, it is possible to prevent the lead wiring or the crossover wiring from being in a stretched state (a state with tension), and it is possible to prevent, for example, occurrence of disconnection. Since the plurality of lead wirings can be arranged side by side in the circumferential direction, the lead wirings can be made fine. Therefore, the number of turns of the coils wound around the teeth is relatively large. Since the width x of the contact portions A and B of the plurality of brushes 7 can be widened, the number of teeth can be reduced to five, the width of the teeth can be widened, and occurrence of magnetic saturation can be prevented.

### Seventh Embodiment

A motor according to the seventh embodiment as an example of the second invention will be described. The motor according to the seventh embodiment is different from the motor 1 according to the first embodiment in the configurations of the magnet and the armature. Specifically, in the present embodiment, the number of magnetic poles of the magnet 6 is eight, the number of slots of the rotor core 2 is ten, and the number of segments of the commutator 4 is 20.

As described above, although the shape of the armature is slightly different, an appearance of the magnet is cylindrical and does not change, and other configurations are the same as the configurations of the first embodiment. Therefore, for the overall configuration of the motor according to the present embodiment, please refer to FIG. 1 representing the motor 1 according to the first embodiment. The same reference numerals as those in the first embodiment are used for the reference numerals. For a large number of teeth, coils and segments, new reference numerals will only be given to numerals of excess parts.

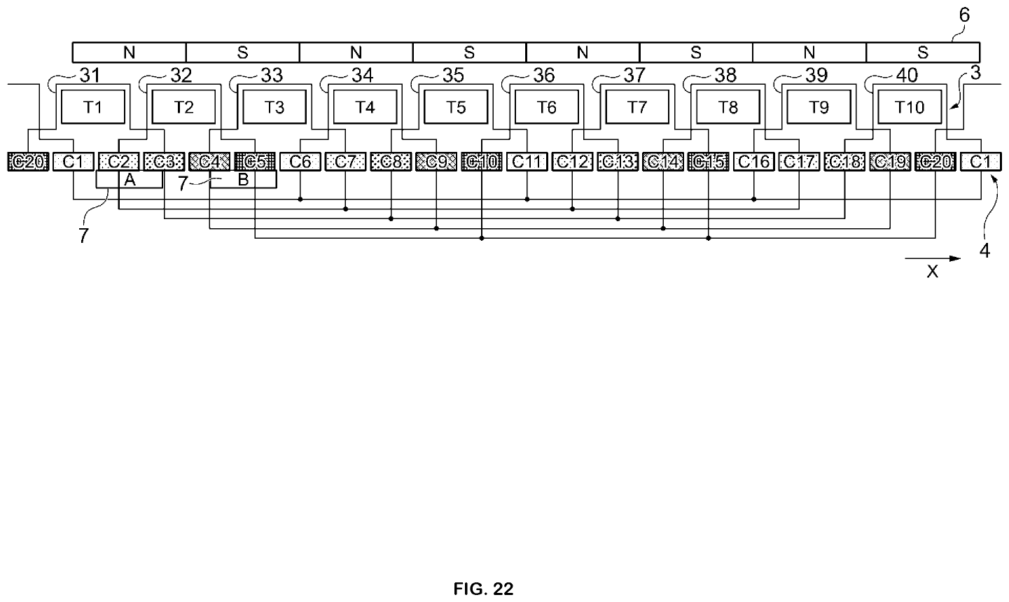

FIG. 22 is a schematic diagram formed by developing each component of an armature arranged in a circumferential direction in a left-right direction, and showing a mutual relationship (positional relationship, connection relationship) in the motor according to the seventh embodiment as an example of the second invention.

As shown in FIG. 22, the rotor core 2 includes the first tooth T1 to the tenth tooth T10 as a plurality of (ten in the present embodiment) slots arranged in the circumferential direction. The coils 31 to 40 are wound around the first tooth T1 to the tenth tooth T10, respectively. The coils 31 to 40 have the same number of turns and the same winding axis direction (spiral direction).

The commutator 4 has segments C1 to C20 as the plurality of segments arranged in the circumferential direction. The segments C1 to C20 are brought into contact with contact portions A and B of the plurality of brushes 7 and energized.

A size relationship between the contact portions A and B of the plurality of brushes 7 and the segments (C1 to C20) in the commutator 4 satisfies the above-described relational expression (1).

In the present embodiment, both ends of each coil 3 are connected to two segments among the plurality of segments C1 to C20, and another two segments are arranged between the two segments. Both ends of the coil 3 are not connected to the another two segments.

In FIG. 22, when the first coil 31 is described as an example, first, both ends of the first coil 31 are connected to two segments C20 and C3. Then, another segments C1 and C2 are arranged between the two segments C20 and C3. Both ends of the first coil 31 are not connected to the another segments C1 and C2.

A relationship between the segments and the coil described above is the same for the remaining second coil 32 to the tenth coil 40.

In the present embodiment, one end of each of two coils adjacent to both sides of the coil is connected to each of the another two segments. Both ends of the coil are not connected to the another two segments.

In FIG. 22, when the first coil 31 is described as an example, one end of each of two coils of the tenth coil 40 and the second coil 32 adjacent to both sides of the first coil 31 is connected to each of the another two segments C1 and C2. Both ends of the first coil 31 are not connected to the another two segments C1 and C2.

Other adjacent relationships of the first coil 31 to the tenth coil 40 are similar to the relationship between the segments and the coils described above.

In the present embodiment, the segments having the rotationally symmetrical positional relationship in the circumferential direction of the commutator 4 (arrow X direction) have the same potential.

In FIG. 22, when the segment C3 is described as a standard, the segments C8, C13, and C18 are in the rotationally symmetrical (specifically, four-fold symmetrical) positional relationship with the segment C3 in the circumferential direction of the commutator 4 (arrow X direction), and the four segments including the segment C3 are connected. Therefore, the segment C3, the segment C8, the segment C13, and the segment C18 have the same potential.

Other relationships among the segments C1 to C20 having the rotationally symmetrical positional relationship in the circumferential direction of the commutator 4 (arrow X direction) are similar to the above relationship among the segments.

Although a detailed description of the operation of the motor according to the present embodiment is omitted, similarly to other embodiments, the rotation of the commutator 4 and the like in the arrow X direction is maintained by applying a predetermined current or voltage to the plurality of brushes 7. The rotation of the motor is continued by further continuing applying a predetermined current or voltage to the plurality of brushes.

According to the motor in the present embodiment, the contact portions A and B of the plurality of brushes 7 are in contact with two or more adjacent segments at the same time. Therefore, since the width x of the contact portions A and B is wide, it is possible to smoothly extend over the slit (gap between adjacent segments) of the commutator 4. Therefore, according to the motor in the present embodiment, since the plurality of brushes 7 are less likely to be shaken, it is possible to reduce noise caused by the shaking of the plurality of brushes 7.

According to the motor in the present embodiment, in a connection method at the time of assembling the armature 10, since the width x of the contact portions A and B of the plurality of brushes 7 is wide, it is possible to improve the energization efficiency and the reliability (in particular, to increase the life of the motor).

Although the commutator has 20 segments, the width x of the contact portions A and B of the plurality of brushes 7 can be widened, so that the number of slots can be reduced to ten. Since it is easy to ensure the space for the winding, a space factor can be improved. As a result, the size of the motor can be reduced and the torque can be increased.

In the motor in the present embodiment, since the coils 3 are concentrated winding and a winding portion can be made thinner than overlapping winding, the number of stacked magnetic bodies (electrical steel plates) constituting the rotor core 2 having the slots can be increased, and magnetic efficiency can be increased.

In the motor in the present embodiment, when an improvement state of the cogging torque with respect to the 8-pole 20-slot motor including the coils wound in the overlapping manner is confirmed, it is possible to confirm the improvement of 10% or more of the load fluctuation rate. Therefore, according to the motor in the present embodiment, it can be seen that the cogging torque can be reduced.

### [Third Invention]

A motor according to a third invention includes:

a magnet including a plurality of magnetic poles;

a plurality of slots opposing the magnet;

a coil wound around each of the plurality of slots;

a commutator including a plurality of segments; and

a plurality of brushes, each of the plurality of brushes including a contact portion contacting two adjacent segments among the plurality of segments, wherein

both ends of the coil are connected to two segments among the plurality of segments, and one or two or more other segments are arranged between the two segments,

one ends of two adjacent coils are connected to one segment of the two segments, and

in a circumferential direction of the commutator, the segments in a rotationally symmetrical positional relationship have the same potential.

Each of the first to fourth embodiments as exemplary aspects of the first invention corresponds to an example of the third invention.

Hereinafter, an eighth embodiment as an exemplary aspect of the third invention will be described with reference to the drawings. The eighth embodiment does not correspond to the example of the first invention.

### Eighth Embodiment

A motor according to an eighth embodiment as an example of the third invention will be described. The motor according to the eighth embodiment is different from the motor 1 according to the first embodiment in the configurations of the magnet and the armature. Specifically, in the present embodiment, the number of magnetic poles of the magnet 6 is eight, the number of slots of the rotor core 2 is nine, and the number of segments of the commutator 4 is 36.

As described above, although the shape of the armature is slightly different, an appearance of the magnet is cylindrical and does not change, and other configurations are the same as the configurations of the first embodiment. Therefore, for the overall configuration of the motor according to the present embodiment, please refer to FIG. 1 representing the motor 1 according to the first embodiment. The same reference numerals as those in the first embodiment are used for the reference numerals. For a large number of teeth, coils and segments, new reference numerals will only be given to numerals of excess parts.

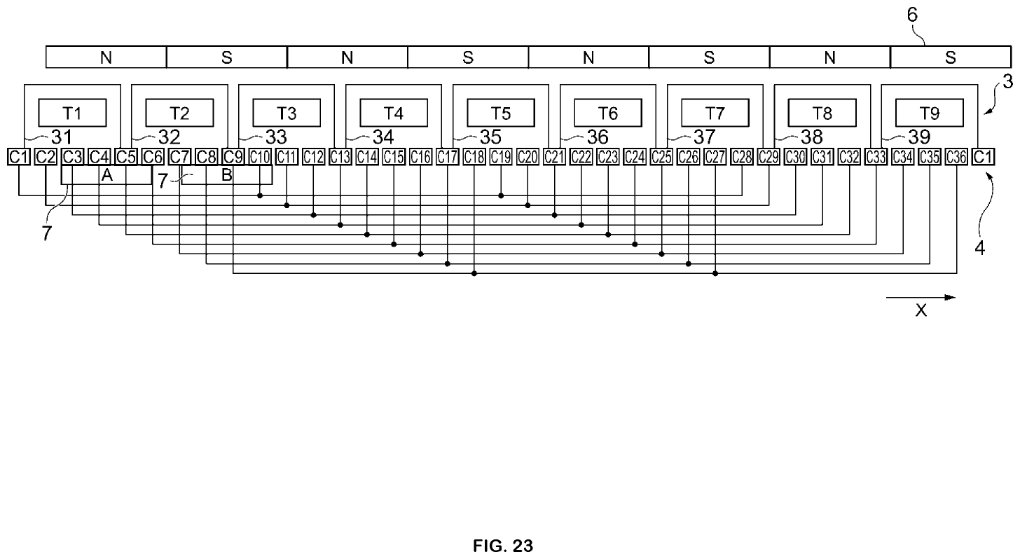

FIG. 23 is a schematic diagram formed by developing each component of an armature arranged in a circumferential direction in a left-right direction, and showing a mutual relationship (positional relationship, connection relationship) in a motor according to the eighth embodiment as an example of the third invention.

As shown in FIG. 23, the rotor core 2 includes the first tooth T1 to the ninth tooth T9 as a plurality of (nine in the present embodiment) slots arranged in the circumferential direction. The coils 31 to 39 are wound around the first tooth T1 to the ninth tooth T9, respectively. The coils 31 to 39 have the same number of turns and the same winding axis direction (spiral direction).

The commutator 4 has segments C1 to C36 as the plurality of segments arranged in the circumferential direction. The segments C1 to C36 are brought into contact with contact portions A and B of the plurality of brushes 7 and energized.

A size relationship between the contact portions A and B of the plurality of brushes 7 and the segments (C1 to C36) in the commutator 4 satisfies the following relational expression (3).

4y+5z>x>3y+4z relational expression (3)

By satisfying the relational expression (3), since the contact portions A and B of the plurality of brushes 7 always come into contact with four or more adjacent segments (x>3y+4z), and the brushes do not come into contact with six or more segments at the same time (4y+5z>x), the short circuit can be prevented.

By satisfying the following relational expression (3′), when the contact portions A and B are each in contact with four segments, both sides of each of the contact portions A and B in the circumferential direction may be prevented from protruding from the segments at the same time.

4y+3z>x>3y+4z relational expression (3′)

In the present embodiment, both ends of each coil 3 are connected to two segments among the plurality of segments C1 to C36, and another three segments are arranged between the two segments. Both ends of the coil 3 are not connected to the another three segments.

In FIG. 23, when the first coil 31 is described as an example, first, both ends of the first coil 31 are connected to two segments C1 and C5. Then, another segments C2, C3, and C4 are arranged between the two segments C1 and C5. Both ends of the coil 3 are not connected to the another segments C2, C3, and C4.

A relationship between the segments and the coil described above is the same for the remaining second coil 32 to the ninth coil 39.

In the present embodiment, the segments having the rotationally symmetrical positional relationship in the circumferential direction of the commutator 4 (arrow X direction) have the same potential.

In FIG. 23, when the segment C3 is described as a standard, the segment C12, the segment C21, and the segment C30 are in the rotationally symmetrical (specifically, four-fold symmetrical) positional relationship with the segment C3 in the circumferential direction of the commutator 4 (arrow X direction), and the four segments including the segment C3 are connected. Therefore, the segment C3, the segment C12, the segment C21, and the segment C30 have the same potential.

Other relationships among the segments C1 to C36 having the rotationally symmetrical positional relationship in the circumferential direction of the commutator 4 (arrow X direction) are similar to the above relationship among the segments.

An operation of the motor according to the present embodiment will be described.

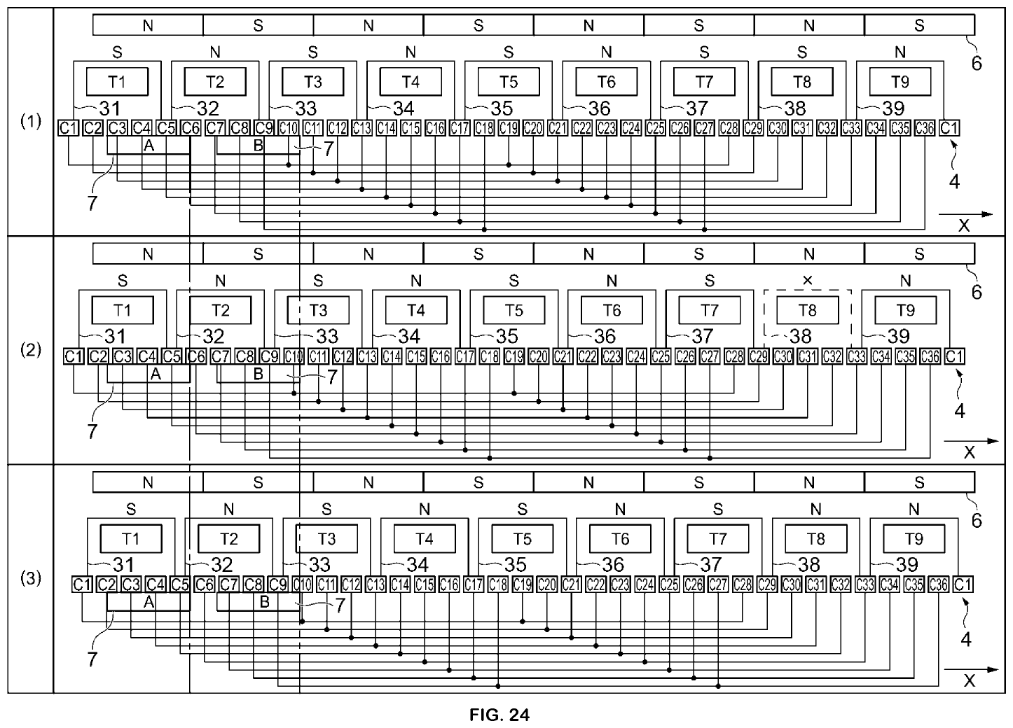

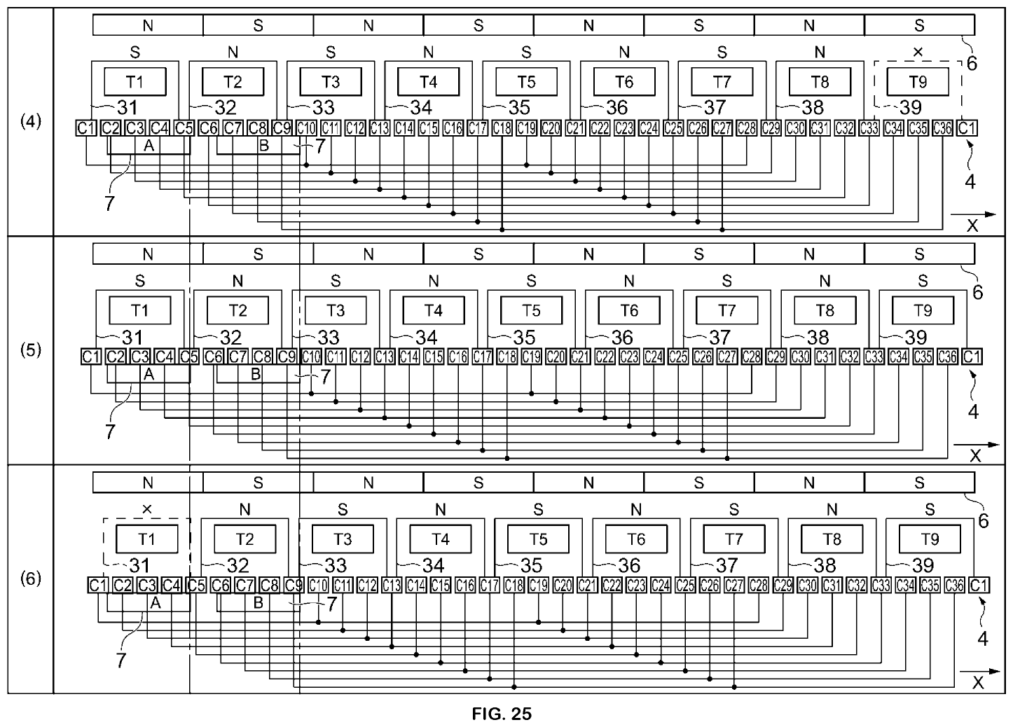

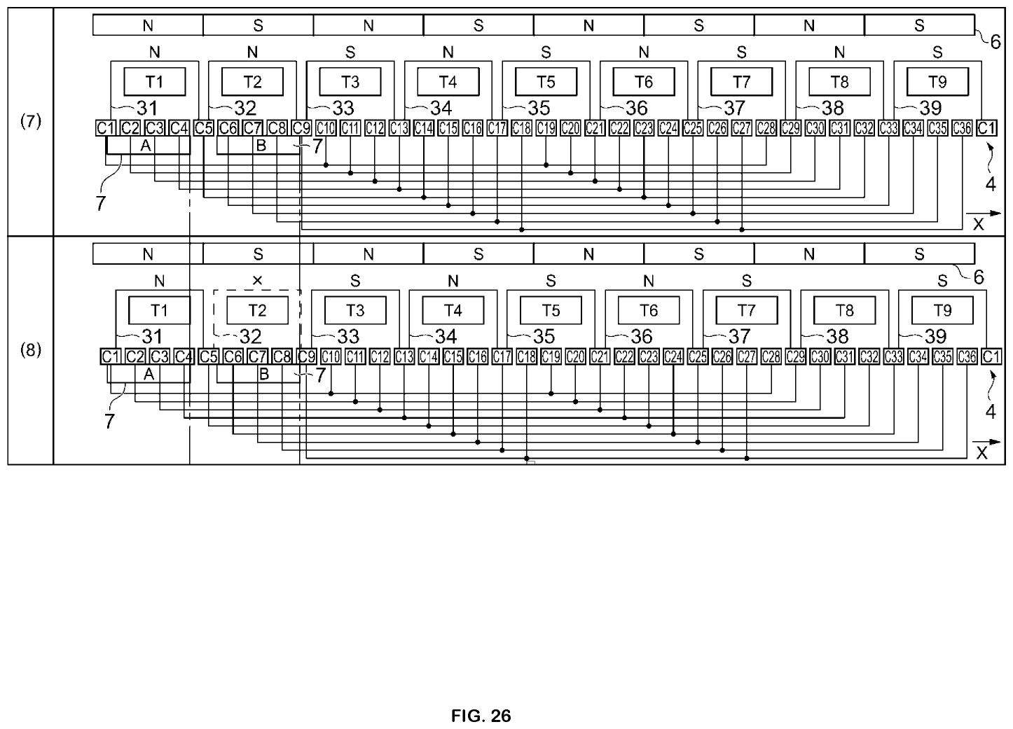

FIGS. 24 to 26 are illustrative diagrams for illustrating a change in a magnetic pole of the slots and a movement of components of the armature 10 in time series when a predetermined current or voltage is applied to the motor according to the present embodiment. Similarly to the schematic diagram in FIG. 23, each diagram of (1) to (3) in FIG. 24, (4) to (6) in FIG. 25, and (7) and (8) in FIG. 26 is obtained by developing each component of the armature 10 arranged in the circumferential direction in a left-right direction, and showing a mutual relationship (positional relationship, connection relationship).

FIGS. 24 to 26 illustrate a state of the teeth T1 to T9 as the components of the armature 10 sequentially moving in the arrow X direction from (1) in FIG. 24 to (8) in FIG. 26 with the lapse of time, and a contact state (energization state) between the contact portions A and B of the plurality of brushes 7 and the segments C1 to C36 is switched. In order to make it easy to understand the positional relationship between the contact portions A and B of the plurality of brushes 7 and the teeth T1 to T9 and the like, in FIGS. 24 to 26, a one-dot chain line is attached to a right end of the contact portion A and a two-dot chain line is attached to a right end of the contact portion B as auxiliary lines over each time series.

First, in the state of FIG. 24(1), a predetermined DC voltage is applied to the contact portions A and B of the plurality of brushes 7 (in the present embodiment, the contact portion A is positive and the contact portion B is negative). In the state of FIG. 24(1), the contact portion A of one brush 7 is in contact with the segments C3, C4, C5 and C6 of the commutator 4, and the contact portion B of the other brush 7 is in contact with the segments C7, C8, C9 and C10.

The applied voltage is applied to each of the first to ninth coils 31 to 39 via each connection wiring according to the contact state between the plurality of brushes 7 and the commutator 4, and a current whose positive and negative directions are selected flows. Then, as shown in FIG. 24(1), the magnetic poles of the teeth T1 to T9 become SNSNSNSSN.

Due to an interaction caused by an attractive force or a repulsive force between the magnetic poles of the teeth T1 to T9 and the magnetic poles of the magnet 6, the teeth (slots) T1 to T9 as the components of the armature 10, the first to ninth coils 31 to 39, and the segments C1 to C36 (hereinafter, may be referred to as “commutator 4 or the like”) move in the arrow X direction, and the shaft 8 rotates.

When the commutator 4 and the like move to the state of FIG. 24(2), the contact portion A of one brush 7 comes into contact with the segments C2, C3, C4, C5 and C6, and the contact portion B of the other brush 7 remains in contact with the segments C7, C8, C9 and C10. Due to the change in the contact state between the plurality of brushes 7 and the commutator 4, the positive and negative directions of the currents flowing through the first to ninth coils 31 to 39 also change. As shown in FIG. 24(2), the magnetic poles of the teeth T1 to T9 are SNSNSNS×N.

Due to the interaction between the magnetic poles of the teeth T1 to T9 and the magnetic poles of the magnet 6 due to the attractive force or the repulsive force, the commutator 4 and the like move in the arrow X direction, and the rotation of the shaft 8 is maintained.

When the commutator 4 and the like move to the state of FIG. 24(3), the contact portion A of one brush 7 comes into contact with the segments C2, C3, C4 and C5, and the contact portion B of the other brush 7 remains in contact with the segments C7, C8, C9 and C10. Due to the change in the contact state between the plurality of brushes 7 and the commutator 4, the positive and negative directions of the currents flowing through the first to ninth coils 31 to 39 also change. As shown in FIG. 24(3), the magnetic poles of the teeth T1 to T9 are SNSNSNSNN.

Due to the interaction between the magnetic poles of the teeth T1 to T9 and the magnetic poles of the magnet 6 due to the attractive force or the repulsive force, the commutator 4 and the like move in the arrow X direction, and the rotation of the shaft 8 is maintained.

Next, when the commutator 4 and the like move to the state of FIG. 25(4), the contact portion A of one brush 7 remains in contact with the segments C2, C3, C4 and C5, and the contact portion B of the other brush 7 is in contact with the segments C6, C7, C8, C9 and C10. Due to the change in the contact state between the plurality of brushes 7 and the commutator 4, the positive and negative directions of the currents flowing through the first to ninth coils 31 to 39 also change. As shown in FIG. 25(4), the magnetic poles of the teeth T1 to T9 are SNSNSNSN×.

Due to the interaction between the magnetic poles of the teeth T1 to T9 and the magnetic poles of the magnet 6 due to the attractive force or the repulsive force, the commutator 4 and the like move in the arrow X direction, and the rotation of the shaft 8 is maintained.

When the commutator 4 and the like move to the state of FIG. 25(5), the contact portion A of one brush 7 remains in contact with the segments C2, C3, C4 and C5, and the contact portion B of the other brush 7 is in contact with the segments C6, C7, C8 and C9. Due to the change in the contact state between the plurality of brushes 7 and the commutator 4, the positive and negative directions of the currents flowing through the first to ninth coils 31 to 39 also change. As shown in FIG. 25(5), the magnetic poles of the teeth T1 to T9 are SNSNSNSNS.

Due to the interaction between the magnetic poles of the teeth T1 to T9 and the magnetic poles of the magnet 6 due to the attractive force or the repulsive force, the commutator 4 and the like move in the arrow X direction, and the rotation of the shaft 8 is maintained.

When the commutator 4 and the like move to the state of FIG. 25(6), the contact portion A of one brush 7 comes into contact with the segments C1, C2, C3, C4 and C5, and the contact portion B of the other brush 7 remains in contact with the segments C6, C7, C8 and C9. Due to the change in the contact state between the plurality of brushes 7 and the commutator 4, the positive and negative directions of the currents flowing through the first to ninth coils 31 to 39 also change. As shown in FIG. 25(6), the magnetic poles of the teeth T1 to T9 are ×NSNSNSNS.

Due to the interaction between the magnetic poles of the teeth T1 to T9 and the magnetic poles of the magnet 6 due to the attractive force or the repulsive force, the commutator 4 and the like move in the arrow X direction, and the rotation of the shaft 8 is maintained.

When the commutator 4 and the like move to the state of FIG. 26(7), the contact portion A of one brush 7 comes into contact with the segments C1, C2, C3 and C4, and the contact portion B of the other brush 7 remains in contact with the segments C6, C7, C8 and C9. Due to the change in the contact state between the plurality of brushes 7 and the commutator 4, the positive and negative directions of the currents flowing through the first to ninth coils 31 to 39 also change. As shown in FIG. 26(7), the magnetic poles of the teeth T1 to T9 are NNSNSNSNS.

Due to the interaction between the magnetic poles of the teeth T1 to T9 and the magnetic poles of the magnet 6 due to the attractive force or the repulsive force, the commutator 4 and the like move in the arrow X direction, and the rotation of the shaft 8 is maintained.

When the commutator 4 and the like move to the state of FIG. 26(8), the contact portion A of one brush 7 remains in contact with the segments C1, C2, C3 and C4, and the contact portion B of the other brush 7 is in contact with the segments C5, C6, C7, C8 and C9. Due to the change in the contact state between the plurality of brushes 7 and the commutator 4, the positive and negative directions of the currents flowing through the first to ninth coils 31 to 39 also change. As shown in FIG. 26(8), the magnetic poles of the teeth T1 to T9 are N×SNSNSNS.

Due to the interaction between the magnetic poles of the teeth T1 to T9 and the magnetic poles of the magnet 6 due to the attractive force or the repulsive force, the commutator 4 and the like move in the arrow X direction, and the rotation of the shaft 8 is maintained.

In the motor 1 according to the present embodiment, by applying the predetermined current or voltage to the plurality of brushes 7, the rotation of the commutator 4 and the like in the arrow X direction is maintained as illustrated in the time series of (1) to (8) in the above FIGS. 24 to 26. The rotation of the motor is continued by further continuing applying the predetermined current or voltage to the plurality of brushes.

According to the motor in the present embodiment, the contact portions A and B of the plurality of brushes 7 are in contact with four or more adjacent segments at the same time. Therefore, since the width x of the contact portions A and B is wide, it is possible to smoothly extend over the slit (gap between adjacent segments) of the commutator 4. Therefore, since the width x of the contact portions A and B is wide, it is possible to smoothly extend over the slit (gap between adjacent segments) of the commutator 4. Therefore, according to the motor in the present embodiment, since the plurality of brushes 7 are less likely to be shaken, it is possible to reduce noise caused by the shaking of the plurality of brushes 7.

According to the motor in the present embodiment, in a connection method at the time of assembling the armature 10, since the width x of the contact portions A and B of the plurality of brushes 7 is wide, it is possible to improve the energization efficiency and the reliability (in particular, to increase the life of the motor).

Although the commutator has 36 segments, the width x of the contact portions A and B of the plurality of brushes 7 can be widened, so that the number of slots can be reduced to nine, and the space for the winding can be easily ensured. Since it is easy to ensure a space for the winding, a space factor can be improved. As a result, the size of the motor can be reduced and torque can be increased.

In the motor in the present embodiment, since the coils 3 are concentrated winding and a winding portion can be made thinner than overlapping winding, the number of stacked magnetic bodies (electrical steel plates) constituting the rotor core 2 having the slots can be increased, and magnetic efficiency can be increased.

In the motor in the present embodiment, when an improvement state of the cogging torque with respect to the 8-pole 20-slot motor including the coils wound in the overlapping manner is confirmed, it is possible to confirm the improvement of 10% or more of the load fluctuation rate. Therefore, according to the motor in the present embodiment, it can be seen that the cogging torque can be reduced.

### [Fourth Invention]

A motor according to a fourth invention includes:

a magnet including a plurality of magnetic poles;

a plurality of slots opposing the magnet;

a coil wound around each of the plurality of slots;

a commutator including a plurality of segments; and

a plurality of brushes, each of the plurality of brushes including a contact portion contacting two or more adjacent segments among the plurality of segments, wherein

both ends of the coil are connected to two segments among the plurality of segments,

one end of another coil is connected to a segment adjacent to the other side of a segment arranged on one side of two segments connected to the coil in a circumferential direction of the commutator,

one end of other further another coil is connected to a segment adjacent to one side of the segment on the other side of two segments connected to the coil in the circumferential direction of the commutator,

a segment not connected to any of the coils is adjacent to one side and the other side of two adjacent segments connected to either of the coils in the circumferential direction of the commutator, and

in the circumferential direction of the commutator, the segments in a rotationally symmetrical positional relationship have the same potential

Hereinafter, ninth to tenth embodiments as exemplary aspects of the fourth invention will be described with reference to the drawings.

### Ninth Embodiment

A motor according to the ninth embodiment as an example of the fourth invention will be described. The motor according to the ninth embodiment is different from the motor 1 according to the first embodiment in the configurations of the magnet and the armature. Specifically, in the present embodiment, the number of magnetic poles of the magnet 6 is six, the number of slots of the rotor core 2 is seven, and the number of segments of the commutator 4 is 21.

As described above, although the shape of the armature is slightly different, an appearance of the magnet is cylindrical and does not change, and other configurations are the same as the configurations of the first embodiment. Therefore, for the overall configuration of the motor according to the present embodiment, please refer to FIG. 1 representing the motor 1 according to the first embodiment. The same reference numerals as those in the first embodiment are used for the reference numerals. For a large number of teeth, coils and segments, new reference numerals will only be given to numerals of excess parts.

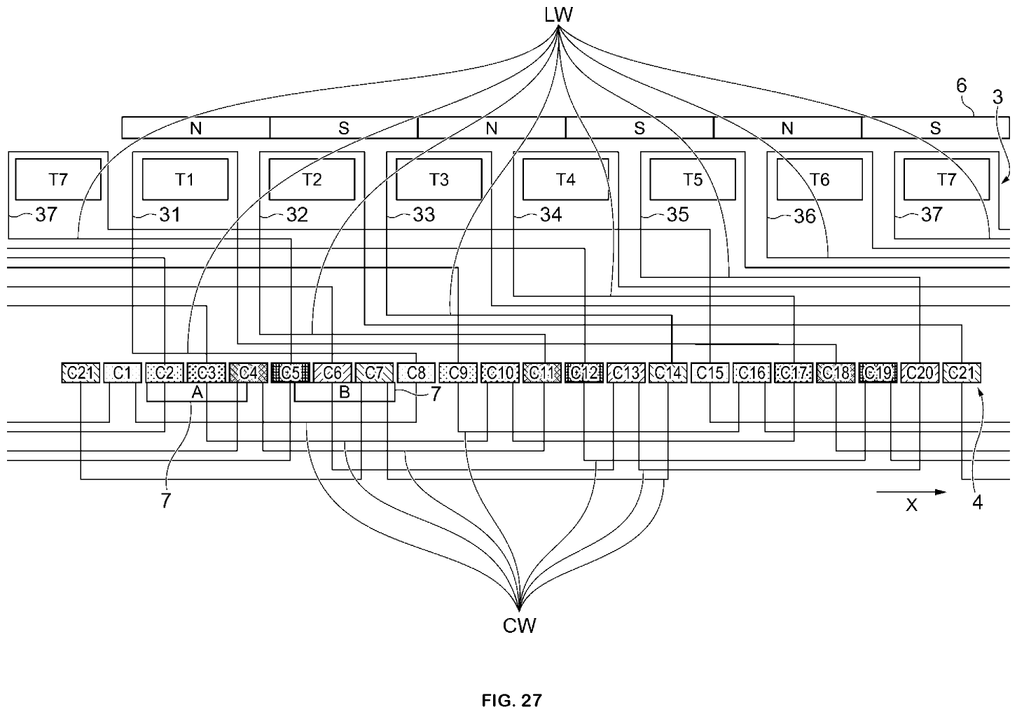

FIG. 27 is a schematic diagram formed by developing each component of an armature arranged in the circumferential direction in a left-right direction, and showing a mutual relationship (positional relationship, connection relationship) in a motor according to the ninth embodiment as an example of the fourth invention.

As shown in FIG. 27, the rotor core 2 includes the first tooth T1 to the seventh tooth T7 as a plurality of (seven in the present embodiment) slots arranged in the circumferential direction. The coils 31 to 37 are wound around the first tooth T1 to the seventh tooth T7, respectively. The coils 31 to 37 have the same number of turns and the same winding axis direction (spiral direction).

The commutator 4 has segments C1 to C21 as the plurality of segments arranged in the circumferential direction. The segments C1 to C21 are brought into contact with the contact portions A and B of the plurality of brushes 7 and energized.

The size relationship between the contact portions A and B of the plurality of brushes 7 and the segments (C1 to C21) in the commutator 4 satisfies the relational expression (2) described above, and may satisfy the relational expression (2′) described above.

In the present embodiment, both ends of each coil 3 are connected to two segments of the plurality of segments C1 to C21.

One end of the other coil is connected to a segment adjacent to the other side of a segment on one side of two segments connected to the coil 3 in the circumferential direction of the commutator 4 (arrow X direction).

One end of the further another coil is connected to the segment adjacent to one side of the segment on the other side of two segments connected to the coil 3 is connected in the circumferential direction of the commutator 4 (arrow X direction).

Then, a segment not connected to any of the coils (not connected to the coil) is adjacent to one side and the other side of two adjacent segments connected to either of the coils in the circumferential direction of the commutator 4 (arrow X direction).

In FIG. 27, when the first coil 31 is described as an example, first, both ends of the first coil 31 are connected to two segments C8 and C18.

One end of the fifth coil 35 (another coil) is connected to the segment C9 adjacent to the other side of the segment C8 on one side of the two segments C8 and C18 connected to the first coil 31 in the circumferential direction of the commutator 4 (arrow X direction).

One end of the fourth coil 34 (further another coil) is connected to the segment C17 adjacent to one side of the segment C18 on the other side of the two segments C8 and C18 connected to the first coil 31 in the circumferential direction of the commutator 4 (arrow X direction).

Then, when the first coil 31 and the fifth coil 35 are described as an example, the segments C7 and C10 not connected to any of the coils 3 (not connected to the coil) are adjacent to one side and the other side of two adjacent segments C8 and C9 connected to the first coil 31 and the fifth coil 35 (either of the coils) in the circumferential direction of the commutator 4 (arrow X direction).

The relationship between the segments and the coil described above is the same for all the segments C1 to C21 and all the first coil 31 to the seventh coil 37.

In the present embodiment, the segments having the rotationally symmetrical positional relationship in the circumferential direction of the commutator 4 (arrow X direction) have the same potential.

In FIG. 27, when the segment C3 is described as a standard, the segment C10 and the segment C17 are in the rotationally symmetrical (specifically, three-fold symmetrical) positional relationship with the segment C3 in the circumferential direction of the commutator 4 (arrow X direction), and the three segments including the segment C3 are connected. Therefore, the segment C3, the segment C10, and the segment C17 have the same potential.

Other relationships among the segments C1 to C21 having the rotationally symmetrical positional relationship in the circumferential direction of the commutator 4 (arrow X direction) are similar to the above relationship among the segments.

FIG. 27 illustrates a state of the crossover wirings CW connected such that a plurality of segments have the same potential. Lead wirings LW drawn out from the coil 3 are curved and routed to connect to the segments. In a radial direction, a gap between two adjacent slits among the plurality of slits and a gap between two adjacent segments oppose each other. The plurality of coils, the plurality of lead wirings, and the plurality of crossover wirings CW may be formed of one conducting wiring.

Although a detailed description of the operation of the motor according to the present embodiment is omitted, similarly to other embodiments, the rotation of the commutator 4 and the like in the arrow X direction is maintained by applying a predetermined current or voltage to the plurality of brushes 7. The rotation of the motor is continued by further continuing applying a predetermined current or voltage to the plurality of brushes.

According to the motor in the present embodiment, the contact portions A and B of the plurality of brushes 7 are in contact with two or more (three or more in the present embodiment) adjacent segments at the same time. Therefore, since the width x of the contact portions A and B is wide, it is possible to smoothly extend over the slit (gap between adjacent segments) of the commutator 4. Therefore, according to the motor in the present embodiment, since the plurality of brushes 7 are less likely to be shaken, it is possible to reduce noise caused by the shaking of the plurality of brushes 7.

According to the motor in the present embodiment, in a connection method at the time of assembling the armature 10, since the width x of the contact portions A and B of the plurality of brushes 7 is wide, it is possible to improve the energization efficiency and the reliability (in particular, to improve the life of the motor).

Although the commutator has 21 segments, the width x of the contact portions A and B of the plurality of brushes 7 can be widened, so that the number of slots can be reduced to seven, and the space for the winding can be easily ensured. Since it is easy to ensure a space for the winding, a space factor can be improved. As a result, the size of the motor can be reduced and the torque can be increased.

In the motor in the present embodiment, since the coils 3 are concentrated winding and a winding portion can be made thinner than overlapping winding, the number of stacked magnetic bodies (electrical steel plates) constituting the rotor core 2 having the slots can be increased, and magnetic efficiency can be increased.

In the motor in the present embodiment, when an improvement state of the cogging torque with respect to the 6-pole 15-slot motor including the coils wound in the overlapping manner is confirmed, it is possible to confirm the improvement of 10% or more of the load fluctuation rate. Therefore, according to the motor in the present embodiment, it can be seen that the cogging torque can be reduced.

In addition, by constituting the wiring structure of the lead wiring and the crossover wiring and the arrangement of the segment and the slit as in the present embodiment, it is possible to prevent the lead wiring or the crossover wiring from being in a stretched state (a state with tension), and it is possible to prevent, for example, occurrence of disconnection. Since the plurality of lead wirings can be arranged side by side in the circumferential direction, the lead wirings can be made fine. Therefore, the number of turns of the coils wound around the teeth is relatively large. Since the width x of the contact portions A and B of the plurality of brushes 7 can be widened, the number of teeth can be reduced to seven, the width of the teeth can be widened, and occurrence of magnetic saturation can be prevented.

### Tenth Embodiment

A motor according to a tenth embodiment as an example of the fourth invention will be described. The motor according to the tenth embodiment is different from the motor 1 according to the first embodiment in the configurations of the magnet and the armature. Specifically, in the present embodiment, the number of magnetic poles of the magnet 6 is eight, the number of slots of the rotor core 2 is nine, and the number of segments of the commutator 4 is 36.

As described above, although the shape of the armature is slightly different, an appearance of the magnet is cylindrical and does not change, and other configurations are the same as the configurations of the first embodiment. Therefore, for the overall configuration of the motor according to the present embodiment, please refer to FIG. 1 representing the motor 1 according to the first embodiment. The same reference numerals as those in the first embodiment are used for the reference numerals. For a large number of teeth, coils and segments, new reference numerals will only be given to numerals of excess parts.

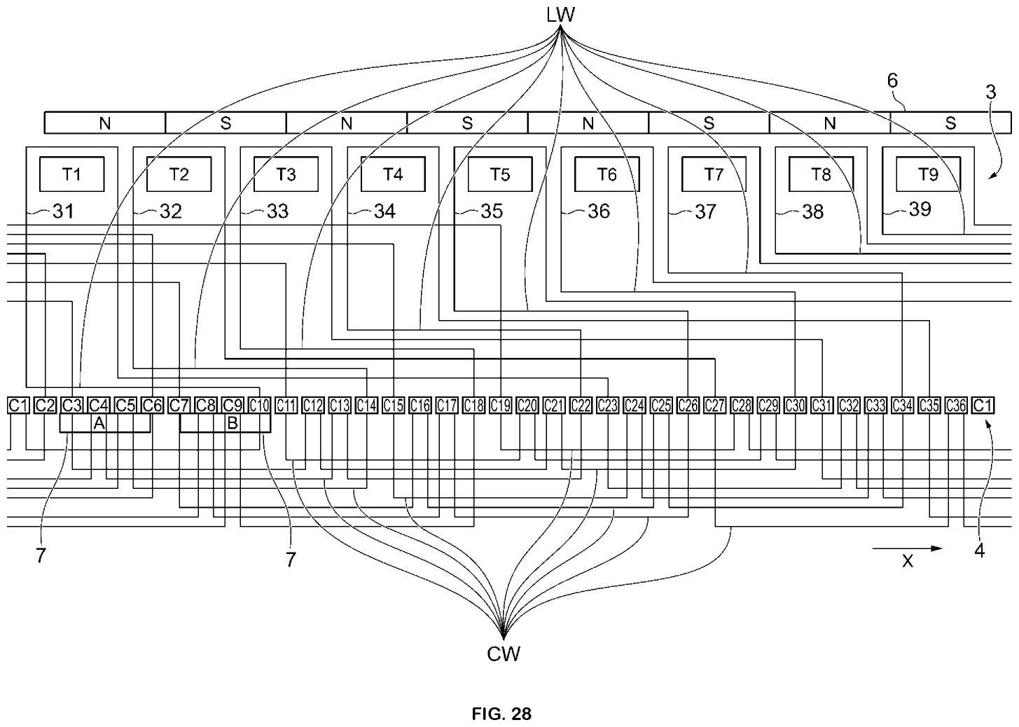

FIG. 28 is a schematic diagram formed by developing each component of an armature arranged in a circumferential direction in a left-right direction, and showing a mutual relationship (positional relationship, connection relationship) in the motor according to the tenth embodiment as an example of the fourth invention.

As shown in FIG. 28, the rotor core 2 includes the first tooth T1 to the ninth tooth T9 as a plurality of (nine in the present embodiment) slots arranged in the circumferential direction. The coils 31 to 39 are wound around the first tooth T1 to the ninth tooth T9, respectively. The coils 31 to 39 have the same number of turns and the same winding axis direction (spiral direction).

The commutator 4 has segments C1 to C36 as the plurality of segments arranged in the circumferential direction. The segments C1 to C36 are brought into contact with contact portions A and B of the plurality of brushes 7 and energized.

The size relationship between the contact portions A and B of the plurality of brushes 7 and the segments (C1 to C21) in the commutator 4 satisfies the relational expression (3) described above, and may satisfy the relational expression (3′) described above.

In the present embodiment, both ends of each coil 3 are connected to two segments of the plurality of segments C1 to C36.

One end of the other coil is connected to a segment adjacent to the other side of a segment on one side of two segments connected to the coil 3 in the circumferential direction of the commutator 4 (arrow X direction).

One end of the further another coil is connected to the segment adjacent to one side of the segment on the other side of two segments connected to the coil 3 in the circumferential direction of the commutator 4 (arrow X direction).

Then, a segment not connected to any of the coils is adjacent to one side and the other side of two adjacent segments connected to either of the coils in the circumferential direction of the commutator 4 (arrow X direction).

In FIG. 28, when the first coil 31 is described as an example, first, both ends of the first coil 31 are connected to two segments C10 and C23.

One end of the seventh coil 37 (another coil) is connected to the segment C11 adjacent to the other side of one segment C10 of the two segments C10 and C23 connected to the first coil 31 in the circumferential direction of the commutator 4 (arrow X direction).

One end of the fourth coil 34 (further another coil) is connected to the segment C22 adjacent to one side of the segment C23 on the other side of the two segments C10 and C23 connected to the first coil 31 in the circumferential direction of the commutator 4 (arrow X direction).

Then, when the first coil 31 and the seventh coil 37 are described as an example, the segments C21 and C24 not connected to any of the coils 3 (not connected to the coil) are adjacent to one side and the other side of two adjacent segments C22 and C23 connected to the first coil 31 and the seventh coil 37 (either of the coils) in the circumferential direction of the commutator 4 (arrow X direction).

The above relationship between the segments and the coil is the same for all the segments C1 to C36 and all the first coil 31 to the ninth coil 39.

In the present embodiment, the segments having the rotationally symmetrical positional relationship in the circumferential direction of the commutator 4 (arrow X direction) have the same potential.

In FIG. 28, when the segment C3 is described as a standard, the segment C12, the segment C21, and the segment C30 are in the rotationally symmetrical (specifically, four-fold symmetrical) positional relationship with the segment C3 in the circumferential direction of the commutator 4 (arrow X direction), and the four segments including the segment C3 are connected. Therefore, the segment C3, the segment C12, the segment C21, and the segment C30 have the same potential.

Other relationships among the segments C1 to C36 having the rotationally symmetrical positional relationship in the circumferential direction of the commutator 4 (arrow X direction) are similar to the above relationship among the segments.

FIG. 28 illustrates a state of the crossover wirings CW connected such that a plurality of segments have the same potential. Lead wirings LW drawn out from the coils 3 are curved and routed to connect to the segments. In a radial direction, a gap between two adjacent slits among the plurality of slits and a gap between two adjacent segments oppose each other. The plurality of coils, the plurality of lead wirings, and the plurality of crossover wirings CW may be formed of one conducting wiring.

Although a detailed description of the operation of the motor according to the present embodiment is omitted, similarly to other embodiments, the rotation of the commutator 4 and the like in the arrow X direction is maintained by applying a predetermined current or voltage to the plurality of brushes 7. The rotation of the motor is continued by further continuing applying a predetermined current or voltage to the plurality of brushes.

According to the motor in the present embodiment, the contact portions A and B of the plurality of brushes 7 are in contact with two or more (four or more in the present embodiment) adjacent segments at the same time. Therefore, since the width x of the contact portions A and B is wide, it is possible to smoothly extend over the slit (gap between adjacent segments) of the commutator 4. Therefore, according to the motor in the present embodiment, since the plurality of brushes 7 are less likely to be shaken, it is possible to reduce noise caused by the shaking of the plurality of brushes 7.

According to the motor in the present embodiment, in a connection method at the time of assembling the armature 10, since the width x of the contact portions A and B of the plurality of brushes 7 is wide, it is possible to improve the energization efficiency and the reliability (in particular, to increase the life of the motor).

Although the commutator has 36 segments, the width x of the contact portions A and B of the plurality of brushes 7 can be widened, so that the number of slots can be reduced to nine, and the space for the winding can be easily ensured. Since it is easy to ensure a space for the winding, a space factor can be improved. As a result, the size of the motor can be reduced and torque can be increased.

In the motor in the present embodiment, since the coils 3 are concentrated winding and a winding portion can be made thinner than overlapping winding, the number of stacked magnetic bodies (electrical steel plates) constituting the rotor core 2 having the slots can be increased, and magnetic efficiency can be increased.

In the motor in the present embodiment, when an improvement state of the cogging torque with respect to the 8-pole 20-slot motor including the coils wound in the overlapping manner is confirmed, it is possible to confirm the improvement of 10% or more of the load fluctuation rate. Therefore, according to the motor in the present embodiment, it can be seen that the cogging torque can be reduced.

In addition, by constituting the wiring structure of the lead wiring and the crossover wiring and the arrangement of the segment and the slit as in the present embodiment, it is possible to prevent the lead wiring or the crossover wiring from being in a stretched state (a state with tension), and it is possible to prevent, for example, occurrence of disconnection. Since the plurality of lead wirings can be arranged side by side in the circumferential direction, the lead wirings can be made fine. Therefore, the number of turns of the coils wound around the teeth is relatively large. Since the width x of the contact portions A and B of the plurality of brushes 7 can be widened, the number of teeth can be reduced to nine, the width of the teeth can be widened, and occurrence of magnetic saturation can be prevented.

### [Fifth Invention]

A motor according to a fifth invention includes:

a magnet including a plurality of magnetic poles;

a plurality of slots opposing the magnet;

a coil wound around each of the plurality of slots;

a commutator including a plurality of segments; and

a plurality of brushes, each of the plurality of brushes including a contact portion contacting two adjacent segments among the plurality of segments, wherein

one end of the coil is connected to one segment among the plurality of segments, the other end of the coil is connected to one end of another coil in an n-fold symmetrical positional relationship in a circumferential direction of the commutator, and the other end of the another coil is connected to another segment among the plurality of segments,

in the circumferential direction of the commutator, one end of the coil adjacent to one side of the coil is connected to the segment as a second segment from one side of the one segment,

the other end of the coil is connected to one end of further another coil in a rotationally symmetrical positional relationship, and the other end of the further another coil is connected to the segment as the second segment from one side of the another segment,

the segment between the segment connected to one end of the coil and the segment connected to one end of the coil adjacent to one side of the coil is not connected to any coil,

the segment between the segment connected to the other end of the another coil and the segment connected to the other end of the coil adjacent to one side of the another coil is not connected to any coil, and

in the circumferential direction of the commutator, the segments in the positional relationship of 2n-fold symmetry have the same potential.

Hereinafter, 11th and 12th embodiments as exemplary aspects of the fifth invention will be described with reference to the drawings.

### 11th Embodiment

A motor according to the 11th embodiment as an example of the fifth invention is different from the motor 1 according to the first embodiment in the configurations of a magnet and an armature. Specifically, in the present embodiment, the number of magnetic poles of the magnet 6 is eight, the number of slots of the rotor core 2 is ten, and the number of segments of the commutator 4 is 20.

As described above, although the shape of the armature is slightly different, an appearance of the magnet is cylindrical and does not change, and other configurations are the same as the configurations of the first embodiment. Therefore, for the overall configuration of the motor according to the present embodiment, please refer to FIG. 1 representing the motor 1 according to the first embodiment. The same reference numerals as those in the first embodiment are used for the reference numerals. For a large number of teeth, coils and segments, new reference numerals will only be given to numerals of excess parts.

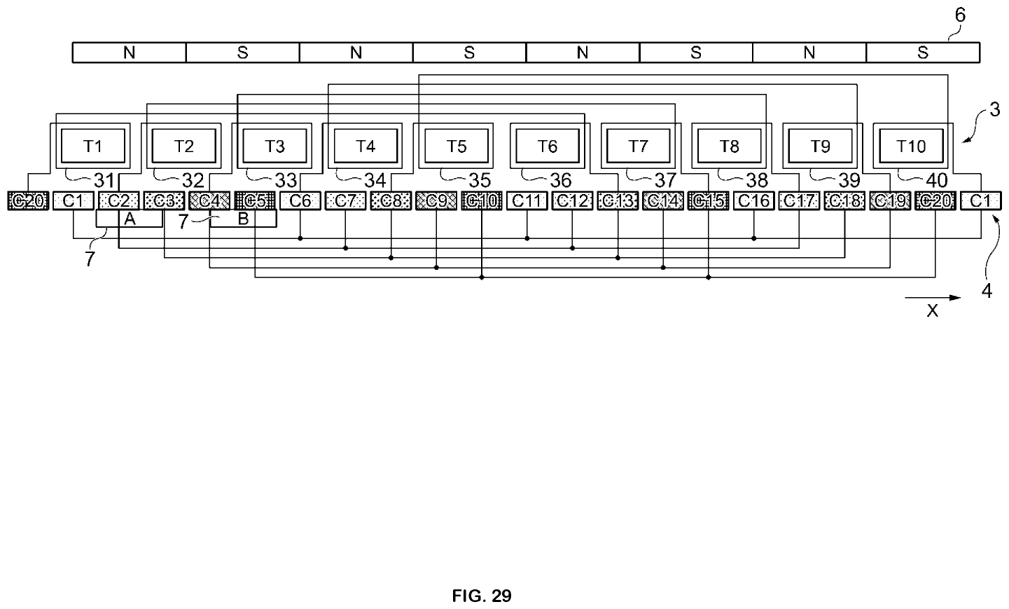

FIG. 29 is a schematic diagram formed by developing each component of an armature arranged in a circumferential direction in a left-right direction, and showing a mutual relationship (positional relationship, connection relationship) in the motor according to the present embodiment.

As shown in FIG. 29, the rotor core 2 includes the first tooth T1 to the tenth tooth T10 as a plurality of (ten in the present embodiment) slots arranged in the circumferential direction. The coils 31 to 40 are wound around the first tooth T1 to the tenth tooth T10, respectively. The coils 31 to 40 have the same number of turns and the same winding axis direction (spiral direction).

The commutator 4 has segments C1 to C20 as the plurality of segments arranged in the circumferential direction. The segments C1 to C20 are brought into contact with contact portions A and B of the plurality of brushes 7 and energized.

A size relationship between the contact portions A and B of the plurality of brushes 7 and the segments (C1 to C20) in the commutator 4 satisfies the above-described relational expression (1).

In the present embodiment, the first tooth T1 to the tenth tooth T10 as slots constituting the armature 10 are arranged so as to have a such a positional relationship that each of the first tooth T1 to the tenth tooth T10 extends over two segments among the segments C1 to C20 in the commutator 4. For example, the first tooth T1 is arranged so as to have such a positional relationship that the first tooth T1 extends over two segments of the segment C1 and the segment C2.

In the present embodiment, one end of the coil 3 is connected to one segment among the plurality of segments, the other end of the coil 3 is connected to one end of another coil 3 having a rotationally symmetrical positional relationship in the circumferential direction of the commutator 4 (arrow X direction), and the other end of the other coil 3 is connected to another segment among the plurality of segments. Focusing on the connection state of the coils 3, one ends of the coils 3 wound around a pair of teeth (slots) having a rotationally symmetrical positional relationship in the circumferential direction of the commutator 4 (arrow X direction) are connected to each other, and the pair of coils 3 are connected in series.

In FIG. 29, when the second tooth T2 is described as an example, one end of the second coil 32 is connected to the second segment C2, the other end of the second coil 32 is connected to one end of the seventh coil (another coil) 37 having the rotationally symmetrical (specifically, two-fold symmetrical) positional relationship in the circumferential direction of the commutator 4 (arrow X direction), and the other end of the seventh coil 37 is connected to the 15th segment C15.

Focusing on the connection state of the second coil 32 and the seventh coil 37, one ends of the second coil 32 and the seventh coil 37 wound around the second tooth T2 and the seventh tooth T7 are connected to each other, and the second coil 32 and the seventh coil 37 are connected in series. The second tooth T2 and the seventh tooth T7 are in the rotationally symmetrical (specifically, two-fold symmetrical) positional relationship in the circumferential direction of the commutator 4 (arrow X direction).

Other relationships between the coils wound around the first tooth T1 to the tenth tooth T10 having a rotationally symmetrical positional relationship (a positional relationship such that the coils oppose each other in the radial direction of the commutator 4) in the circumferential direction of the commutator 4 (arrow X direction) are similar to the relationship between the coils described above.

In the present embodiment, in the circumferential direction of the commutator 4 (arrow X direction), one end of the coil adjacent to one side of the coil 3 is connected to the segment 4 as the second segment from one side of one segment 4. The other end of the coil adjacent to one side of the coil 3 is connected to one end of further another coil 3 having a rotationally symmetrical positional relationship, and the other end of the further another coil is connected to the segment 4 as the second segment from one side of another segment 4.

In FIG. 29, when the second coil 32 wound around the second tooth T2 is described as an example, in the circumferential direction of the commutator 4 (arrow X direction), one end of the first coil 31 adjacent to one side of the second coil 32 is connected to the 20th segment C20 as the second segment from one side of the second segment C2. The other end of the first coil 31 adjacent to one side of the second coil 32 is connected to one end of further another seventh coil 37 having the rotational symmetrical (specifically, two-fold symmetrical) positional relationship, and the other end of the further seventh coil 37 is connected to the segment C13 as the second segment from one side of the other segment C15.

In the present embodiment, both ends of the pair of coils 3 connected in series are in a state of being connected to two segments 4 adjacent to the side further away from the segments 4 on the far side among sets of two segments 4 having such a positional relationship that the teeth (slots) with the coils 3 respectively wound therearound extend over the respective sets of two segments 4.

In FIG. 29, when the first tooth T1 and the sixth tooth T6 connected in series are described as an example, both ends of the first coil 31 and the sixth coil 36 connected in series are in a state of being connected to two segments, namely, the 20th segment C20 and the 13th segment C13 adjacent to the side further away from the first segment C1 and the 12th segment C12, respectively, on the far side among the first segment C1 and the second segment C2 as a set of two segments over which the tooth (slot) T1 with the first coil 31 wound around the tooth T1 extends, and the 11th segment C11 and the 12th segment C12 as another set of two segments over which the tooth (slot) T6 with the sixth coil 36 wound around the tooth T6 extends.

Further, in the present embodiment, the segment 4 located between the segment 4 connected to one end of the coil 3 and the segment 4 connected to one end of the coil 3 adjacent to one side of the coil 3 is not connected to any coil 3. The segment 4 located between the segment 4 connected to the other end of the other coil 3 having the rotationally symmetrical positional relationship and the segment 4 connected to the other end of the coil 3 adjacent to one side of the other coil 3 is not connected to any coil 3 and is not connected to the coil 3.

In FIG. 29, when the second coil 32 is described as an example, the first segment C1 located between the second segment C2 connected to one end of the second coil 32 and the 20th segment C20 connected to one end of the first coil 31 adjacent to one side of the second coil 32 is not connected to any coil 3 and is not connected to the coil 3. The 14th segment 14 located between the 15th segment C15 connected to the other end of the seventh coil (another coil) 37 having the rotationally symmetrical positional relationship with the second coil 32 and the 13th segment C13 connected to the other end of the sixth coil 36 adjacent to one side of the seventh coil 37 is not connected to any coil 3.

Other relationships between the coils wound around the first tooth T1 to the tenth tooth T10 having the rotationally symmetrical positional relationship in the circumferential direction of the commutator 4 (arrow X direction) are similar to the connection relationship between the coils and the segments described above.

In the present embodiment, when the symmetry of the plurality of teeth (slots) with a pair of coils connected in series wound around the plurality of teeth is n-fold symmetry (two-fold symmetry in the present embodiment), segments in a positional relationship of 2n-fold symmetry (2×2-fold symmetry in the present embodiment) have the same potential.

In FIG. 29, when the first segment C1 is described as a standard, the sixth segment C6, the 11th segment C11, and the 16th segment C16 are in a four-fold symmetrical (2×2-fold symmetrical) positional relationship with the first segment C1, and these four segments including the first segment C1 are connected. Therefore, the first segment C1, the sixth segment C6, the 11th segment C11, and the 16th segment C16 have the same potential.

Other relationships between the segments in the segments C1 to C20 are similar to the relationship between the segments described above.

Although a detailed description of the operation of the motor according to the present embodiment is omitted, similarly to other embodiments, the rotation of the commutator 4 and the like in the arrow X direction is maintained by applying a predetermined current or voltage to the plurality of brushes 7. The rotation of the motor is continued by further continuing applying a predetermined current or voltage to the plurality of brushes.

According to the motor in the present embodiment, the contact portions A and B of the plurality of brushes 7 are in contact with two or more adjacent segments at the same time. Therefore, since the width x of the contact portions A and B is wide, it is possible to smoothly extend over the slit (gap between adjacent segments) of the commutator 4. Therefore, according to the motor in the present embodiment, since the plurality of brushes 7 are less likely to be shaken, it is possible to reduce noise caused by the shaking of the plurality of brushes 7.

According to the motor in the present embodiment, in a connection method at the time of assembling the armature 10, since the width x of the contact portions A and B of the plurality of brushes 7 is wide, it is possible to improve the energization efficiency and the reliability (in particular, to increase the life of the motor).

Although the commutator has 20 segments, the width x of the contact portions A and B of the plurality of brushes 7 can be widened, so that the number of slots can be reduced to ten. Since it is easy to ensure the space for the winding, a space factor can be improved. As a result, the size of the motor can be reduced and the torque can be increased.

In the motor in the present embodiment, since the coils 3 are concentrated winding and a winding portion can be made thinner than overlapping winding, the number of stacked magnetic bodies (electrical steel plates) constituting the rotor core 2 having the slots can be increased, and magnetic efficiency can be increased.

In the motor in the present embodiment, when an improvement state of the cogging torque with respect to the 8-pole 20-slot motor including the coils wound in the overlapping manner is confirmed, it is possible to confirm the improvement of 10% or more of the load fluctuation rate. Therefore, according to the motor in the present embodiment, it can be seen that the cogging torque can be reduced.

### 12th Embodiment

A motor according to the 12th embodiment as an example of the fifth invention is different from the motor 1 according to the first embodiment in the configurations of a magnet and an armature. Specifically, in the present embodiment, the number of magnetic poles of the magnet 6 is eight, the number of slots of the rotor core 2 is ten, and the number of segments of the commutator 4 is 20.

As described above, although the shape of the armature is slightly different, an appearance of the magnet is cylindrical and does not change, and other configurations are the same as the configurations of the first embodiment. Therefore, for the overall configuration of the motor according to the present embodiment, please refer to FIG. 1 representing the motor 1 according to the first embodiment. The same reference numerals as those in the first embodiment are used for the reference numerals. For a large number of teeth, coils and segments, new reference numerals will only be given to numerals of excess parts.

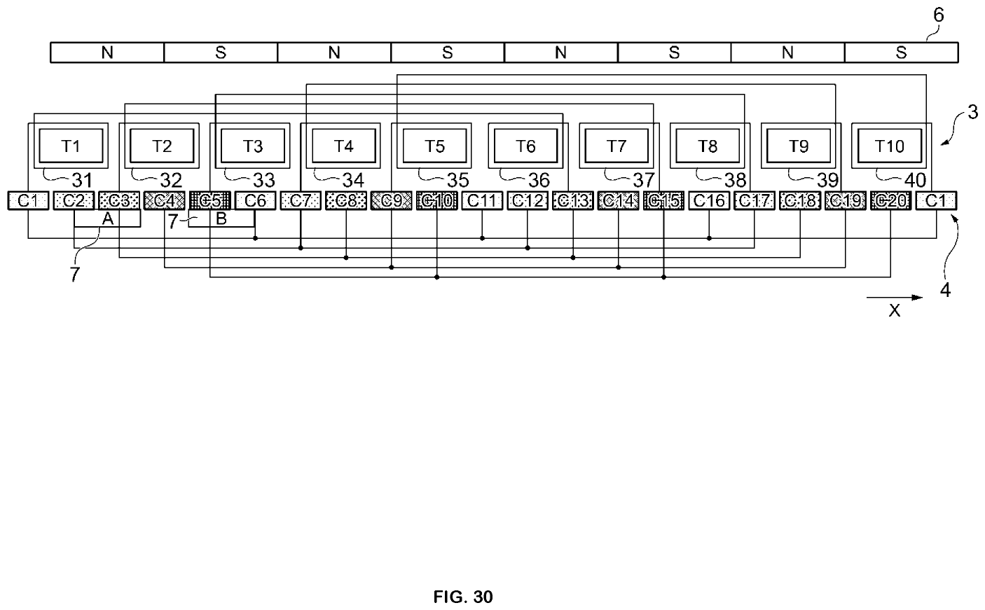

FIG. 30 is a schematic diagram formed by developing each component of an armature arranged in a circumferential direction in a left-right direction, and showing a mutual relationship (positional relationship, connection relationship) in the motor according to the present embodiment.

The motor according to the present embodiment is different from the motor according to the 11-th embodiment only in the positional relationship between the first tooth T1 to the tenth tooth T10 and the segments C1 to C20 and the positional relationship between the coil 3 and the segments C1 to C20.

As shown in FIG. 30, the rotor core 2 includes the first tooth T1 to the tenth tooth T10 as a plurality of (ten in the present embodiment) slots arranged in the circumferential direction. The coils 31 to 40 are wound around the first tooth T1 to the tenth tooth T10, respectively. The coils 31 to 40 have the same number of turns and the same winding axis direction (spiral direction).

The commutator 4 has segments C1 to C20 as the plurality of segments arranged in the circumferential direction. The segments C1 to C20 are brought into contact with contact portions A and B of the plurality of brushes 7 and energized.

A size relationship between the contact portions A and B of the plurality of brushes 7 and the segments (C1 to C20) in the commutator 4 satisfies the above-described relational expression (1).

In the present embodiment, the first tooth T1 to the tenth tooth T10 as slots constituting the armature 10 are arranged so as to have such a positional relationship that each of the teeth T1 to T10 extends over three segments among the segments C1 to C20 in the commutator 4. For example, the first tooth T1 is disposed so as to have such a positional relationship that the first tooth T1 extends over three segments, namely, the segment C1, the segment C2, and the segment C3.

In the present embodiment, one end of the coil 3 is connected to one segment among the plurality of segments, the other end of the coil 3 is connected to one end of another coil 3 having a rotationally symmetrical positional relationship in the circumferential direction of the commutator 4 (arrow X direction), and the other end of the other coil 3 is connected to another segment among the plurality of segments. Focusing on the connection state of the coils 3, one ends of the coils 3 wound around a pair of teeth (slots) in a rotationally symmetrical positional relationship in the circumferential direction of the commutator 4 (arrow X direction) are connected to each other, and the pair of coils 3 are connected in series.

In FIG. 30, when the second tooth T2 is described as an example, one end of the second coil 32 is connected to the third segment C3, the other end of the second coil 32 is connected to one end of the seventh coil (another coil) 37 having the rotationally symmetrical (specifically, two-fold symmetrical) positional relationship in the circumferential direction of the commutator 4 (arrow X direction), and the other end of the seventh coil 37 is connected to the 15th segment C15.

Focusing on the connection state of the second coil 32 and the seventh coil 37, one ends of the second coil 32 and the seventh coil 37 wound around the second tooth T2 and the seventh tooth T7 are connected to each other, and the second coil 32 and the seventh coil 37 are connected in series. The second tooth T2 and the seventh Tooth T7 have the rotationally symmetrical (specifically, two-fold symmetrical) positional relationship in the circumferential direction of the commutator 4 (arrow X direction).

Other relationships between the coils wound around the first tooth T1 to the tenth tooth T10 having the rotationally symmetrical positional relationship in the circumferential direction of the commutator 4 (arrow X direction) are similar to the relationship between the segments described above.

In the present embodiment, in the circumferential direction of the commutator 4 (arrow X direction), one end of the coil 3 adjacent to one side of the coil 3 is connected to the segment 4 as the second segment from one side of one segment 4. The other end the coil 3 adjacent to one side of the coil 3 is connected to one end of further another coil 3 having a rotationally symmetrical positional relationship, and the other end of the further another coil 3 is connected to the segment 4 as the second segment from one side of another segment 4.

In FIG. 30, when the second coil 32 wound around the second tooth T2 is described as an example, in the circumferential direction of the commutator 4 (arrow X direction), one end of the first coil 31 adjacent to one side of the second coil 32 is connected to the first segment C1 as the second segment from one side of the third segment C3. The other end of the first coil 31 adjacent to one side of the second coil 32 is connected to one end of further another sixth coil 6 having the rotational symmetrical (specifically, two-fold symmetrical) positional relationship, and the other end of the sixth coil 6 is connected to the segment C13 as the second segment from one side of the other segment C15.

In the present embodiment, both ends of the pair of coils 3 connected in series are connected to two segments 4 on the farthest side among sets of three segments having such a positional relationship that the teeth (slots) with the coils 3 respectively wound therearound extend over the respective sets of three segments 4.

In FIG. 30, when the first tooth T1 and the sixth tooth T6 connected in series are described as an example, both ends of the first coil 31 and the sixth coil 36 connected in series are in a state of being connected to the first segment C1 and the 13th segment C13, respectively, on the farthest side among the first segment C1, the second segment C2, and the third segment C3 as a set of three segments over which the tooth (slot) T1 with the first coil 31 wound around the tooth T1 extends, and the 11th segment C11, the 12th segment C12, and the 13th segment C13 as another set of three segments over which the tooth (slot) T6 with the sixth coil 36 wound around the tooth T6 extends.

Further, in the present embodiment, the segment 4 located between the segment 4 connected to one end of the coil 3 and the segment 4 connected to one end of the coil 3 adjacent to one side of the coil 3 is not connected to any coil 3. The segment 4 located between the segment 4 connected to the other end of the other coil 3 in the rotationally symmetrical positional relationship and the segment 4 connected to the other end of the coil 3 adjacent to one side of the other coil 3 is not connected to any coil 3.

In FIG. 30, when the second coil 32 is described as an example, the second segment C2 located between the third segment C3 connected to one end of the second coil 32 and the first segment C1 connected to one end of the first coil 31 adjacent to one side of the second coil 32 is not connected to any coil 3. The 14th segment 14 located between the 15th segment C15 connected to the other end of the seventh coil (another coil) 37 in a rotationally symmetrical positional relationship with the second coil 32 and the 13th segment C13 connected to the other end of the sixth coil 36 adjacent to one side of the seventh coil 37 is not connected to any coil 3.

Other relationships between the coils wound around the first tooth T1 to the tenth tooth T10 having the rotationally symmetrical positional relationship in the circumferential direction of the commutator 4 (arrow X direction) are similar to the connection relationship between the coils and the segments described above.

In the present embodiment, when the symmetry of the plurality of teeth (slots) with a pair of coils connected in series wound around the plurality of teeth is n-fold symmetry (two-fold symmetry in the present embodiment), segments having a positional relationship of 2n-fold symmetry (2×2-fold symmetry in the present embodiment) have the same potential.

In FIG. 30, when the first segment C1 is described as a standard, the sixth segment C6, the 11th segment C11, and the 16th segment C16 are in a four-fold symmetrical (2×2-fold symmetrical) positional relationship with the first segment C1, and these four segments including the first segment C1 are connected. Therefore, the first segment C1, the sixth segment C6, the 11th segment C11, and the 16th segment C16 have the same potential.

Other relationships between the segments in the segments C1 to C20 are similar to the relationship between the segments described above.

Although a detailed description of the operation of the motor according to the present embodiment is omitted, similarly to other embodiments, the rotation of the commutator 4 and the like in the arrow X direction is maintained by applying a predetermined current or voltage to the plurality of brushes 7. The rotation of the motor is continued by further continuing applying a predetermined current or voltage to the plurality of brushes.

According to the motor in the present embodiment, the contact portions A and B of the plurality of brushes 7 are in contact with two or more adjacent segments at the same time. Therefore, since the width x of the contact portions A and B is wide, it is possible to smoothly extend over the slit (gap between adjacent segments) of the commutator 4. Therefore, according to the motor in the present embodiment, since the plurality of brushes 7 are less likely to be shaken, it is possible to reduce noise caused by the shaking of the plurality of brushes 7.

According to the motor in the present embodiment, in a connection method at the time of assembling the armature 10, since the width x of the contact portions A and B of the plurality of brushes 7 is wide, it is possible to improve the energization efficiency and the reliability (in particular, to increase the life of the motor).

Although the commutator has 20 segments, the width x of the contact portions A and B of the plurality of brushes 7 can be widened, so that the number of slots can be reduced to ten. Since it is easy to ensure the space for the winding, a space factor can be improved. As a result, the size of the motor can be reduced and the torque can be increased.

In the motor in the present embodiment, since the coils 3 are concentrated winding and a winding portion can be made thinner than overlapping winding, the number of stacked magnetic bodies (electrical steel plates) constituting the rotor core 2 having the slots can be increased, and magnetic efficiency can be increased.

In the motor in the present embodiment, when the improvement state of the cogging torque with respect to the 8-pole 20-slot motor including the coils wound in the overlapping manner is confirmed, it can be confirmed that the load fluctuation rate is improved. Therefore, according to the motor in the present embodiment, it can be seen that the cogging torque can be reduced.

### [Modification]

In addition to the configuration of the inventions described above, present inventors have found a motor that is a concentrated winding brush motor and that can be expected to have the same effect as the inventions even when a combination of the number of magnetic poles of a magnet, the number of slots of an armature, and the number of segments of a commutator is the following (1) to (4), or when the combination is a multiple of each of the following combinations (when a plurality of the same configurations are connected in series or in parallel).

(1) The magnet has four poles, the armature has seven slots, and the commutator has 14 segments.

(2) The magnet has four poles, the armature has five slots, and the commutator has ten segments.

(3) The magnet has six poles, the armature has seven slots, and the commutator has 21 segments.

(4) The magnet has 8 poles, the armature has 9 slots, and the commutator has 36 segments.

Further, in addition to the inventions, the inventors have found a motor that can be expected to have the same effect as that of the inventions with respect to the configuration in the above cases (1) to (4) or in a case of a multiple of each of the configurations of (1) to (4) (when a plurality of same configurations are connected in series or in parallel) which includes the same number as or half the number of poles of a magnet (for example, four brushes when the magnet has four poles, six brushes when the number of poles of the magnet is six, and eight or four brushes when the number of poles of the magnet is eight), in which each end of the coil is connected to two segments among a plurality of segments, and another two segments where neither end of the coil is connected are arranged between the two segments.

When four brushes are provided, the intermediate segments having the same potential in the configuration of the invention are electrically floating segments (dummy segments) not having the same potential.

Although the motor according to the invention and the motor according to the modification are described with reference to the preferred embodiments, the motor according to the invention is not limited to the configuration of the above-described embodiments. For example, the number of magnetic poles of the magnet, the number of slots of the armature, and the number of segments of the commutator in the above embodiments are all examples, and can be appropriately selected on condition that the conditions of the invention are satisfied.

In addition, those skilled in the art can appropriately modify the motor according to the invention in accordance with known knowledge in the related art. Such modifications are also included in the scope of the invention as long as the modifications include the configuration of the invention.

What is claimed is:

1. A motor comprising:
a magnet including a plurality of magnetic poles;
a plurality of slots opposing the magnet;
a coil wound around each of the plurality of slots;
a commutator including a plurality of segments; and
a plurality of brushes, each of the plurality of brushes including a contact portion contacting two adjacent segments among the plurality of segments, wherein
both ends of the coil are connected to the two segments among the plurality of segments, and another segment is arranged between the two segments,
one ends of two adjacent coils are connected to one segment of the two segments, and
a segment connected to one ends of two adjacent coils and the another segment between two segments connected to either coil different from the two adjacent coils have the same potential.

2. The motor according to claim 1, wherein
in a circumferential direction of the commutator, a position of the segment connected to one ends of two adjacent coils and a position of the another segment having the same potential as potential of the segment are in a rotationally symmetrical positional relationship.

3. A motor comprising:
a magnet including a plurality of magnetic poles;
a plurality of slots opposing the magnet;
a coil wound around each of the plurality of slots;
a commutator including a plurality of segments; and
a plurality of brushes, each of the plurality of brushes including a contact portion contacting two adjacent segments among the plurality of segments, wherein
both ends of the coil are connected to two segments among the plurality of segments, and another two segments are arranged between the two segments,
one ends of two coils adjacent to both sides of the coil are respectively connected to the another two segments, and
in a circumferential direction of the commutator, the segments in a rotationally symmetrical positional relationship have the same potential.

4. The motor according to claim 1, wherein
the magnet includes an even number of magnetic poles,
the number of the slots is m, m being an odd number, and
the brush contacts two or more of the segments.

5. The motor according to claim 1, wherein
a width of a contact portion of the brush with the commutator in the circumferential direction of the commutator is x,
a width of the segment in the circumferential direction of the commutator is y, and
when a gap between the two adjacent segments in the circumferential direction of the commutator is z, the following relational expression (1) is satisfied.
2y+3z>x>y+2z relational expression (1)

6. The motor according to claim 1, wherein
a width of a contact portion of the brush contacting the commutator in the circumferential direction of the commutator is x,
a width of the segment in the circumferential direction of the commutator is y, and
when a gap between the two adjacent segments in the circumferential direction of the commutator is z, the following relational expression (2) is satisfied.
3y+4z>x>2y+3z relational expression (2)

7. A motor comprising:
a magnet including a plurality of magnetic poles;
a plurality of slots opposing the magnet;
a coil wound around each of the plurality of slots;
a commutator including a plurality of segments; and
a plurality of brushes, each of the plurality of brushes including a contact portion contacting two adjacent segments among the plurality of segments, wherein
both ends of the coil are connected to two segments among the plurality of segments, and one or two or more other segments are arranged between the two segments,
one ends of two adjacent coils are connected to one segment of the two segments, and
in a circumferential direction of the commutator, the segments in a rotationally symmetrical positional relationship have the same potential.

8. A motor comprising:
a magnet including a plurality of magnetic poles;
a plurality of slots opposing the magnet;
a coil wound around each of the plurality of slots;
a commutator including a plurality of segments; and
a plurality of brushes, each of the plurality of brushes including a contact portion contacting two or more adjacent segments among the plurality of segments, wherein
both ends of the coil are connected to two segments among the plurality of segments,
one end of another coil is connected to a segment adjacent to the other side of a segment arranged on one side of two segments connected to the coil in a circumferential direction of the commutator,
one end of other further another coil is connected to a segment adjacent to one side of the segment on the other side of two segments connected to the coil in the circumferential direction of the commutator,
a segment not connected to any of the coils is adjacent to one side and the other side of two adjacent segments connected to either of the coils in the circumferential direction of the commutator, and
in the circumferential direction of the commutator, the segments in a rotationally symmetrical positional relationship have the same potential.

9. A motor comprising:
a magnet including a plurality of magnetic poles;
a plurality of slots opposing the magnet;
a coil wound around each of the plurality of slots;
a commutator including a plurality of segments; and
a plurality of brushes, each of the plurality of brushes including a contact portion contacting two adjacent segments among the plurality of segments, wherein
one end of the coil is connected to one segment among the plurality of segments, the other end of the coil is connected to one end of another coil in an n-fold symmetrical positional relationship in a circumferential direction of the commutator, and the other end of the another coil is connected to another segment among the plurality of segments,
in the circumferential direction of the commutator, one end of the coil adjacent to one side of the coil is connected to the segment as a second segment from one side of the one segment,
the other end of the coil is connected to one end of further another coil in a rotationally symmetrical positional relationship, and the other end of the further another coil is connected to the segment as the second segment from one side of the another segment,
the segment between the segment connected to one end of the coil and the segment connected to one end of the coil adjacent to one side of the coil is not connected to any coil,
the segment between the segment connected to the other end of the another coil and the segment connected to the other end of the coil adjacent to one side of the another coil is not connected to any coil, and
in the circumferential direction of the commutator, the segments in the positional relationship of 2n-fold symmetry have the same potential.
